(19) United States
(12) Patent Application Publication
(10) Pub. No.: US 2026/0279346 A1
(43) Pub. Date: Sep. 17, 2026

(54) SYSTEM

(71) Applicant: SoftBank Group Corp., Tokyo (JP)

(72) Inventor: Yusuke KATAFUCHI, Tokyo (JP)

(73) Assignee: SoftBank Group Corp., Tokyo (JP)

(21) Appl. No.: 19/546,484

(22) Filed: Feb. 23, 2026

Related U.S. Application Data
(60) Provisional application No. 63/772,140, filed on Mar. 14, 2025.

(51) Int. Cl. G10L 15/18; G06T 13/40; G09B 21/04; G10L 25/30; G10L 25/63

(52) U.S. Cl. CPC G10L 15/1807; G06T 13/40; G09B 21/04; G10L 25/30; G10L 25/63

(57) ABSTRACT

A system includes a processor that is configured to obtain audio data via an audio input unit, analyze the audio data via a speech recognition unit and convert the audio data into text data, analyze prosodic features of the audio data via an emotion identification unit and identify emotion information based on the prosodic features, generate a sign language expression based on the text data and the emotion information via a sign language translation unit, and generate character animation for visually displaying the sign language expression via an animation display unit.

### CROSS-REFERENCE TO RELATED APPLICATION

This application claims the benefit of U.S. Provisional Application No. 63/772,140, filed on Mar. 14, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional communication support systems for deaf and hard-of-hearing users primarily rely on text captions or simplified graphical indicators to represent spoken content. Such systems typically fail to convey the rich emotional nuance and prosodic information inherent in speech, including tone, pitch, speed, and emphasis. As a result, deaf users often receive only a literal transcription of spoken words without the associated emotional context, which can lead to misunderstandings, reduced engagement, and an asymmetric communication experience compared to hearing participants. Existing sign language translation solutions, where available, are frequently limited to static or predefined sign vocabularies and do not dynamically adapt sign expressions to the detected emotional state of the speaker or to the grammatical and structural rules of sign language. Moreover, current avatar-based sign language animations often lack naturalness and accuracy in reproducing hand movements, facial expressions, and body posture, which reduces intelligibility and user acceptance, particularly in demanding scenarios such as remote conferences. Therefore, there is a need for a system capable of automatically converting spoken audio into sign language expressions that accurately reflect both the semantic content and the emotional characteristics of the speech, and for presenting such expressions as natural and easily understandable character animations so that deaf users can effectively receive both content and emotion comparable to hearing users.

### SUMMARY

To solve the above-described problems, an aspect of the invention provides a system comprising a processor, wherein the processor is configured to obtain audio data via an audio input unit, analyze the audio data via a speech recognition unit and convert the audio data into text data, analyze prosodic features of the audio data via an emotion identification unit and identify emotion information based on the prosodic features, generate a sign language expression based on the text data and the emotion information via a sign language translation unit, and generate character animation for visually displaying the sign language expression via an animation display unit. In one embodiment, the processor is further configured to map an audio signal to corresponding text using an acoustic model and a language model in the speech recognition unit, analyze tone, pitch, speed, and emphasis of the audio data using a machine learning algorithm in the emotion identification unit, and generate a context-appropriate sign language expression by understanding sign language grammar and structure in the sign language translation unit. In another embodiment, the processor is configured to generate character animation for accurately reproducing movements of the sign language expression using motion capture technology and three-dimensional modeling in the animation display unit, to make the sign language expression visually easy to understand, and to effectively convey content and emotion of the audio to a deaf person in a remote conference or similar situation. By integrating speech recognition, emotion identification based on prosodic analysis, grammar-aware sign language translation, and naturalistic avatar animation, the system enables deaf users to receive both the semantic content and emotional nuance of spoken communication in an intuitive and accessible sign language form.

The term “system” refers to an integrated combination of hardware and software components that cooperatively perform the functions recited in the claims, including acquiring audio data, recognizing speech, identifying emotion, translating into sign language, and generating character animation.

The term “processor” refers to one or more hardware processing units, such as a CPU, GPU, DSP, or other computational circuitry, configured by software or firmware to execute the functions and algorithms described in the claims.

The term “audio input unit” refers to a hardware and/or software component, such as a microphone and its associated interface, that captures sound from an environment and outputs corresponding audio data in a digital or digitizable form.

The term “audio data” refers to digital or digitized representations of sound signals, including sampled waveforms or encoded streams derived from captured speech.

The term “speech recognition unit” refers to a hardware and/or software module that analyzes audio data to detect linguistic content and converts the audio data into corresponding text data.

The term “text data” refers to a sequence of characters, words, or other textual symbols representing the linguistic content recognized from audio data.

The term “emotion identification unit” refers to a hardware and/or software module that analyzes prosodic or other acoustic features of audio data to determine corresponding emotion information.

The term “prosodic features” refers to measurable characteristics of speech, including but not limited to tone, pitch, speed, rhythm, pauses, emphasis, and loudness, that are indicative of how something is spoken rather than what is spoken.

The term “emotion information” refers to data representing an estimated emotional state associated with the audio data, such as joy, anger, sadness, surprise, neutrality, or other affective categories, optionally including confidence scores or intensity values.

The term “sign language translation unit” refers to a hardware and/or software module that generates a sign language expression based on input text data and emotion information, in accordance with grammatical and structural rules of a target sign language.

The term “sign language expression” refers to a representation of linguistic content using sign language, including handshapes, hand movements, orientations, spatial locations, facial expressions, and body postures sufficient to express meaning and emotion.

The term “animation display unit” refers to a hardware and/or software module that generates and outputs character animation frames for visually displaying a sign language expression on a display device.

The term “character animation” refers to a time-varying sequence of visual frames or pose data controlling a graphical character or avatar, including movements of limbs and changes in facial expressions, to depict a sign language expression.

The term “acoustic model” refers to a model, typically implemented by statistical or machine learning techniques, that relates acoustic features of audio data to basic linguistic units such as phonemes, characters, or subword units for use in speech recognition.

The term “language model” refers to a model that assigns probabilities to sequences of words or other linguistic units, used to improve the accuracy of speech recognition by constraining or ranking candidate text outputs.

The term “machine learning algorithm” refers to an algorithm or model trained on example data to infer patterns, such as relationships between prosodic features and emotion categories, and to output predictions for new input data.

The term “sign language grammar and structure” refers to the syntactic, morphological, and spatial rules that govern how signs, non-manual markers, and spatial arrangements are combined to form meaningful sign language utterances in a given language or region.

The term “motion capture technology” refers to techniques and equipment used to record movements of a human performer or objects, and to convert those movements into digital motion data that can drive a computer-generated character.

The term “three-dimensional modeling” refers to the creation and use of three-dimensional geometric representations of characters or objects, including skeletal rigs and mesh surfaces, for use in rendering and animating character animation.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

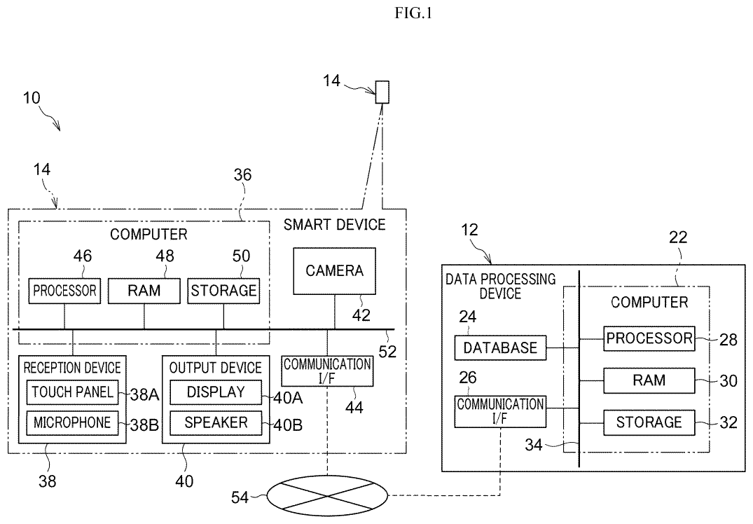

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

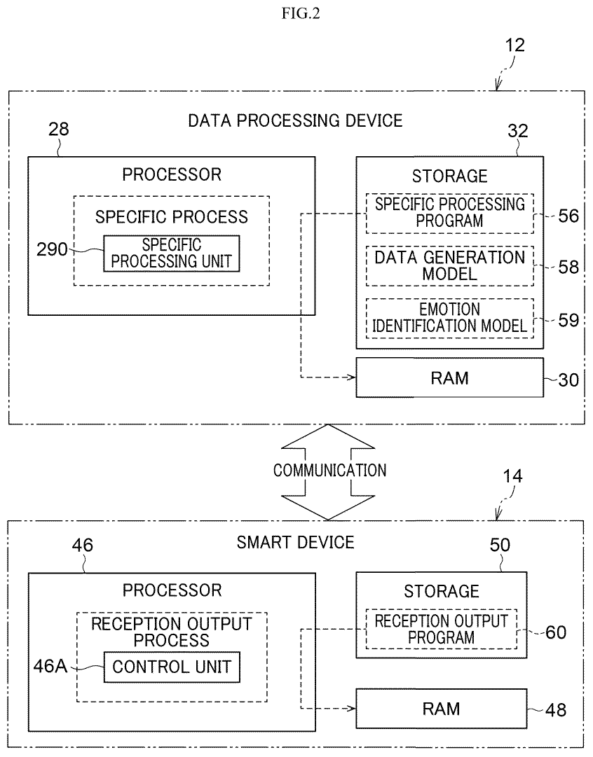

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented speech-to-text and captioning systems primarily focus on converting audio signals into textual information, and therefore fail to convey rich non-verbal and emotional aspects of spoken communication to users who rely on visual modalities, such as sign language users. Existing systems that attempt to generate sign language animations from text often employ rigid rule-based mappings, do not leverage prosodic features of speech, and do not dynamically adapt motion style or facial expressions based on contextual emotion. As a result, such systems produce animations that are semantically shallow, emotionally flat, and difficult to follow in real-time conversational environments such as remote conferences.

Furthermore, typical architectures treat automatic speech recognition and emotion analysis as independent subsystems and do not integrate them in a coordinated processing pipeline that is explicitly optimized for generating expressive sign language animation data. In many implementations, sign language generation is performed as a simple post-processing step on recognized text, without utilizing prosodic information (for example, fundamental frequency, intensity, speaking rate, and pause duration) or user-specific characteristics, and without exploiting modern generative models that can learn complex mappings from multimodal input to structured sign representations.

In addition, existing content generation frameworks that use generative models are generally designed for natural language output and are not configured to produce structured sign language representations that can be directly converted into low-level animation scripts controlling a skeletal rig and facial expression parameters of a virtual avatar. Consequently, these systems cannot efficiently generate time-aligned joint trajectories, facial expression curves, and other animation control data necessary for high-fidelity, real-time sign language rendering on resource-constrained terminals.

Therefore, there is a need for an improved computer-implemented technique that: (i) jointly processes audio recognition and prosodic emotion analysis; (ii) constructs prompt sentences tailored for a generative model to produce structured sign language expression data; (iii) converts such structured data into optimized animation scripts for three-dimensional avatar control; and (iv) supports user-specific customization of avatar appearance and motion characteristics. Such a technique should improve the overall efficiency, accuracy, and expressiveness of the end-to-end pipeline from spoken input to sign language animation, thereby improving the functioning of the underlying computer system itself in terms of multimodal data processing and rendering.

The specific processing by the specific processing unit 290 of the data processing device 12 in Example 1 is realized by the following means.

The present invention provides a server comprising a processor and a memory storing instructions that, when executed by the processor, cause the processor to receive audio information from an information processing terminal via a communication network, analyze the audio information using an acoustic model and a language model to generate character information, extract prosodic feature quantities from the audio information and classify the prosodic feature quantities using a machine learning method to specify emotion information, generate a sign language intermediate representation including a target sign language type and non-manual behavior on the basis of the character information and the emotion information, construct a prompt sentence including the sign language intermediate representation, the emotion information, and the target sign language type, supply the prompt sentence to a generative model to obtain structured sign language expression data, convert the structured sign language expression data into an animation script including skeletal information, joint angle information, and facial expression information suitable for controlling a virtual avatar, and transmit the animation script to the information processing terminal for three-dimensional rendering with user-configurable avatar appearance and motion characteristics. This enables an integrated, computer-implemented pipeline that improves the functioning of the computing system by more efficiently and accurately transforming audio input and prosodic emotion features into structured sign language animation control data, thereby providing expressive, real-time sign language visualizations that better convey both semantic content and emotional nuance to users.

The term “audio information” refers to a digital representation of sound captured by an input device, including sequences of samples or encoded frames that express human speech and acoustic characteristics over time.

The term “information processing terminal” refers to an electronic device operated by a user, such as a general-purpose computing device or communication device, that is configured to capture audio information, communicate with a server, and render visual output.

The term “information processing apparatus” refers to a computing system, such as a server or server cluster, that includes at least one processor and memory and is configured to perform analysis, transformation, and generation of data including audio information, character information, and animation data.

The term “communication network” refers to a wired or wireless data transmission infrastructure, including local networks and wide-area networks, through which the information processing terminal and the information processing apparatus exchange data.

The term “acoustic model” refers to a computational model, often implemented using statistical or machine learning methods, that maps audio feature quantities derived from audio information to probabilistic representations of phonetic or sub-word units.

The term “language model” refers to a computational model that assigns probabilities to sequences of tokens or characters and is used to determine a most likely textual sequence from candidate outputs of an acoustic model.

The term “character information” refers to textual data, including sequences of characters, words, or tokens, generated by converting audio information into a linguistic representation.

The term “prosodic feature quantities” refers to numerical values derived from audio information that represent suprasegmental characteristics of speech, including at least fundamental frequency, intensity, speech rate, and pause duration.

The term “machine learning method” refers to a computational technique that uses training data to learn parameters of a model and that can classify, regress, or otherwise infer outputs, including emotion information, from input feature quantities.

The term “emotion information” refers to data representing an estimated emotional state associated with spoken content, including at least an emotion category and optionally an intensity or confidence value.

The term “sign language intermediate representation” refers to a structured data format that encodes a sequence of sign units, grammatical structure, and non-manual behaviors, and that is suitable for further transformation into sign language expression data.

The term “target sign language type” refers to a specification of a particular sign language variant, such as a national or regional sign language, that determines vocabulary, grammar, and non-manual expression conventions for sign generation.

The term “non-manual behavior” refers to components of sign language expression that are not formed by hand movements, including at least facial expressions, head movements, shoulder movements, and body posture.

The term “prompt sentence” refers to a text sequence supplied as input to a generative model, the text sequence including instructions, constraints, or conditioning information such as sign language type, intermediate representation, and emotion information.

The term “generative AI model” refers to a computational model, often implemented using deep learning, that generates output data such as structured sign language representations in response to input data including a prompt sentence.

The term “sign language expression data” refers to data generated by a generative AI model that describes sign language content, including at least sign units, temporal ordering, and associated non-manual markers.

The term “structured sign language expression data” refers to sign language expression data organized in a machine-readable format, including explicit fields for hand shape, position, movement, duration, and facial expression tags.

The term “animation script” refers to a data structure that defines time-dependent control parameters for an avatar, including at least skeletal information, joint angle information, and facial expression information for generating motion.

The term “skeletal information” refers to data describing a hierarchical arrangement of virtual joints or bones of a virtual character used to define body structure for animation.

The term “joint angle information” refers to time-varying values specifying rotations or positions of individual joints in a skeletal structure for controlling limb and body motion.

The term “facial expression information” refers to parameters, such as blendshape weights or joint rotations, that control visible changes in a virtual character's face to represent expressions corresponding to linguistic or emotional content.

The term “virtual person” refers to a computer-generated character or avatar with a graphical representation, a skeletal structure, and facial controls, which can be animated to perform sign language.

The term “three-dimensional image processing” refers to computational operations for generating and displaying three-dimensional graphics, including transforming, animating, and rendering a virtual person in a three-dimensional scene.

The term “motion characteristics” refers to properties of the movement of a virtual person, including at least motion speed, amplitude, smoothness, and expressiveness of gestures and facial expressions.

The term “user setting” refers to configuration information specified or selected by a user that affects processing or presentation, including at least avatar appearance preferences and motion characteristic preferences.

The term “analysis sections of a predetermined time length” refers to contiguous segments of audio information having a fixed or predefined duration that are used as units for feature extraction and recognition processing.

The term “audio feature quantities” refers to numerical descriptors computed from audio information, including but not limited to spectral coefficients, cepstral coefficients, energy, and temporal statistics.

The term “search processing” refers to a computational procedure that explores candidate hypotheses, such as possible character sequences, and selects an optimal or near-optimal hypothesis based on probabilities from an acoustic model and a language model.

The term “field-specific dictionary data” refers to lexical resources that include domain-dependent terms, technical terminology, and specialized expressions used to bias or correct recognition results for a specific application field.

The term “context information” refers to data representing surrounding or related linguistic, situational, or discourse conditions, including prior utterances, conversation topic, or application scenario, used to guide generation of sign language output.

The term “intensity index of non-manual behavior” refers to a numerical or categorical value indicating the strength or degree of non-manual behavior, such as how strongly facial expressions, head movements, or body posture changes should be expressed.

The term “joint motion sequence” refers to an ordered series of joint configurations over time that describes the movement of skeletal joints of a virtual person.

The term “facial expression change sequence” refers to an ordered series of facial expression parameter values over time that describes dynamic changes in the facial appearance of a virtual person.

The term “time axis” refers to a representation of temporal progression along which joint motion sequences and facial expression change sequences are placed and coordinated for playback.

In one embodiment, the server, the terminal, and the user cooperate to implement the invention using general-purpose computing hardware and specialized software modules.

The terminal includes a processor, a memory, a microphone, a display, a network interface, and optionally a graphics processing unit. The terminal executes an operating system such as a mobile operating system, a desktop operating system, or a browser environment. The terminal uses an audio capture library, such as an audio recording interface, an audio engine, or a web audio interface, to sample the user's voice through the microphone and to generate digital audio information. The terminal uses a communication library, such as an HTTPS client or a WebSocket client, to transmit the audio information to the server via a wired or wireless communication network.

The server includes a processor, a memory, a non-volatile storage device, and a network interface. The server may be implemented as a single hardware device or a plurality of interconnected hardware devices. The server executes an operating system such as a server operating system and a server-side framework such as a web application framework or a real-time communication framework. The server stores program modules including an audio reception module, a speech recognition module, an emotion recognition module, a sign language intermediate representation module, a generative AI model interface module, an animation script generation module, and a communication module.

The server receives audio information from the terminal through the network interface. The server stores the received audio information in a memory buffer controlled by the audio reception module. The server optionally decodes compressed audio frames using a codec library and resamples the audio information to a target sampling frequency suitable for subsequent analysis. The server normalizes the audio amplitude and applies digital signal processing, such as noise reduction and voice activity detection, to improve the signal-to-noise ratio. This pre-processing reduces computational load and improves the accuracy of downstream models, which constitutes a technical improvement in audio processing efficiency.

The server uses the speech recognition module to convert the audio information into character information. The server uses a feature extraction library, such as a digital signal processing library, to compute frame-based feature vectors, for example Mel-frequency cepstral coefficients, filter bank energies, and pitch-related features. The server inputs the feature vectors into an acoustic model implemented as a deep neural network, for example a convolutional-recurrent network or a Transformer-based network constructed in a numerical computation framework. The server configures the network with multiple layers including an input layer corresponding to feature dimensions, multiple hidden layers (convolutional layers, recurrent layers, or self-attention layers), and an output layer corresponding to phonetic or subword units. The server trains the acoustic model offline by minimizing an objective function such as a connectionist temporal classification loss or cross-entropy loss using gradient-based optimization, such as stochastic gradient descent or an adaptive optimization algorithm. During training, the server updates model parameters based on backpropagation, uses mini-batch processing, and optionally applies data augmentation techniques such as time-warping, frequency-masking, and additive noise injection to improve robustness.

The server combines the acoustic model output with a language model, for example an n-gram model or a neural language model, using a decoding algorithm such as beam search. The server maintains a search graph that represents candidate token sequences and expands the graph by combining acoustic scores and language model scores. The server applies a pruning strategy to discard low-probability paths, thereby reducing computational complexity and improving decoding speed. The server references field-specific dictionary data stored in a database to adjust scores for domain-specific terms. This integrated decoding process yields character information with reduced error rates compared to naive speech-to-text conversion and improves computational efficiency by focusing processing resources on the most likely hypotheses.

The server uses the emotion recognition module to determine emotion information from the audio information. The server extracts prosodic feature quantities including fundamental frequency, energy, speaking rate, and pause duration by analyzing the audio waveform and its spectral representation. The server segments the audio information into analysis windows and computes statistical descriptors, such as mean, variance, range, and slope, for each prosodic feature over the windows. The server optionally stores user-specific baseline profiles and normalizes the prosodic features relative to the baseline to distinguish emotional variation from individual speaking style. The server inputs the normalized feature vectors into an emotion classifier configured as a recurrent neural network, for example a long short-term memory network or a gated recurrent unit network, or a Transformer-based classifier. The server trains the emotion classifier using supervised learning with labeled emotional speech data, a loss function such as cross-entropy, and optimization algorithms similar to those used for the acoustic model. The server may perform class balancing, regularization, and early stopping to prevent overfitting.

The server outputs an emotion label, such as joy, anger, sadness, surprise, or neutral, and optionally an intensity value representing a confidence or strength of the emotion. By using a dedicated prosodic feature space and a temporal neural architecture, the server achieves higher emotion recognition accuracy and real-time performance compared with human manual annotation or simplified rule-based systems. This constitutes an improvement of the computer's ability to interpret audio signals by exploiting fine-grained temporal and spectral patterns that are not practically trackable by human operators in real time.

The server uses the sign language intermediate representation module to transform the character information and the emotion information into a representation suited for sign generation. The server uses a natural language processing toolkit to perform tokenization, part-of-speech tagging, and syntactic parsing on the character information. The server identifies grammatical roles such as subject, verb, and object and determines topicalized elements. The server applies rule-based transformations specific to sign language word order, such as topic-comment rearrangement and omission of function words not necessary in sign language. The server inserts non-manual markers based on the emotion information and syntactic emphasis, for example attaching emphasis markers to certain signs when the emotion intensity exceeds a threshold. The server constructs an intermediate data structure that stores a sequence of sign units, grammatical annotations, non-manual markers, and a target sign language type. This intermediate structure allows the server to separate language analysis from motion realization, and it reduces redundant computation when similar sentences are processed repeatedly.

The server uses the generative AI model interface module to prepare a prompt sentence for a generative AI model. The server assembles text that instructs the generative AI model to output structured sign language expression data. For example, the server constructs prompt sentences such as:

“Translate the following sentence into sign language gloss. Include detailed instructions for facial expressions and movement size. The overall emotion is joy. Sentence: ‘We just exceeded our quarterly target by 50 percent.’”

“Convert this Japanese sentence into sign language notation. The emotion is surprise. Add explicit facial expression tags and emphasize sudden movements. Sentence: ‘I can't believe that this is actually happening.’”

“Generate a sign language sequence with gloss and non-manual markers. The emotion is sadness. Text: ‘I am sorry for your loss.’”

The server may adapt the prompt sentence content based on the target sign language type, the complexity of the source sentence, or the detected emotion intensity. The server thereby uses prompt engineering as an explicit control mechanism for the generative AI model. This non-conventional use of prompt sentences to request structured, machine-readable sign language data is distinct from ordinary use of generative models for free-form natural language output and results in model outputs that can be directly mapped to animation control parameters.

The server transmits the prompt sentence to the generative AI model through an application programming interface. The generative AI model may be a sequence-to-sequence model implemented as a Transformer network, configured with an encoder that reads the prompt sentence and a decoder that outputs a structured text representation of sign language. The generative AI model is trained beforehand on pairs of text and sign representations, where the sign representation includes gloss sequences and non-manual markers, and optionally on synthetic data that augments rare grammatical patterns. The server adjusts the decoding temperature, maximum output length, or other inference parameters to balance diversity and determinism in the generated output.

The server receives sign language expression data from the generative AI model. The sign language expression data includes explicit tags for hand shape, location relative to the body, movement type, movement direction, duration, and facial expressions. The server parses this structured text into an internal data structure, for example a list of sign elements with associated attributes and temporal offsets. The server validates the structure by checking that required fields are present for each sign element and that timing constraints do not produce overlapping motions that violate kinematic limits of the avatar skeleton. This structured representation enables the server to perform algorithmic checks and optimizations that are not possible with unstructured natural language output.

The server uses the animation script generation module to convert the structured sign language expression data into an animation script suitable for driving a three-dimensional avatar on the terminal. The server maintains a motion dictionary that maps sign units and movement tags to motion primitives, such as joint angle curves or stored motion capture segments. The server retrieves the corresponding motion primitives for each sign element and adjusts them according to the emotion-dependent attributes, such as scaling movement amplitude for joyful expressions or shortening duration for urgent expressions. The server computes a time axis and places each sign's joint trajectories and facial expression curves on the axis while ensuring smooth transitions between signs, for example by blending overlapping keyframes and applying interpolation algorithms such as cubic splines or spherical linear interpolation for rotations.

The server outputs an animation script as a machine-readable data structure that includes skeletal information, joint angle information over time, and facial expression information over time. The server optionally compresses the animation script using a lossless compression method to reduce communication load between the server and the terminal. By pre-computing joint trajectories and blendshape curves on the server, the system reduces the computational burden on the terminal and permits low-latency playback even on terminals with limited processing power. This division of labor between server-side motion generation and terminal-side rendering improves system scalability and responsiveness compared with architectures that attempt to compute all motion on the terminal.

The terminal receives the animation script from the server. The terminal stores the animation script in memory and uses a three-dimensional graphics engine, such as a game engine or a web-based 3D framework, to control the skeletal structure and facial expression parameters of a virtual person. The terminal loads a rigged avatar model, which includes a hierarchical skeleton with joints for spine, shoulders, elbows, wrists, fingers, neck, and facial control points or blendshape targets. The terminal maps the joint angle information in the animation script to the skeleton joints and maps the facial expression information to the corresponding facial control parameters.

The terminal controls the graphics processing unit to render the avatar in real time at a given frame rate. At each frame, the terminal interpolates between keyframes specified in the animation script to obtain continuous joint transformations and facial expressions. The terminal applies the transformations to the avatar mesh, performs lighting calculations, and rasterizes the image on the display. The terminal positions the virtual camera to show the upper body and face clearly, improving legibility of the sign language. Because the animation script has been optimized to avoid unnecessary joint motion and to use compressed representations, the terminal can render the animation with low latency and reduced power consumption, thereby improving the technical performance of the terminal.

The terminal provides a user interface for avatar customization. The user selects avatar appearance attributes, such as body type, clothing style, and color scheme, and motion characteristics, such as overall signing speed, gesture amplitude, and facial expressiveness. The terminal stores these user settings locally and may send them to the server so that future animation scripts can be generated with these preferences in mind. Alternatively, the terminal adjusts the timing and amplitude scaling of the received animation script according to user settings, for example by stretching the time axis for slower playback or scaling joint angles for more subtle motion. This client-side adaptation avoids regenerating full animations on the server and thus reduces network traffic and server load, while still allowing individualized presentation.

In one variation, the server and the terminal both cache frequently used animation fragments, such as common phrases or greeting expressions, along with associated sign language expression data. When the same or similar character information and emotion information appear, the server retrieves the cached animation fragments instead of re-invoking the generative AI model and motion generation pipeline. This caching mechanism reduces repeated computation and decreases response time, again demonstrating an improvement in computing resource utilization rather than mere automation of human interpretation.

In another variation, the server employs different neural network architectures and training strategies for specific languages or domains. For example, the server may use a Transformer-based acoustic model for one spoken language and a recurrent-convolutional hybrid model for another, based on empirical performance on domain-specific data. The server may also adjust loss functions, such as combining cross-entropy loss with auxiliary losses that encourage monotonic alignments, to improve robustness in noisy environments. These design choices reflect targeted improvements to the internal operation of the computing system, enhancing recognition and generation performance in ways that are not practical for human interpreters.

In yet another variation, the server incorporates a feedback mechanism based on user interaction. The terminal allows the user to rate the clarity or naturalness of generated sign animations or to request repetition at different speeds. The server collects this feedback and updates model parameters periodically using online learning or fine-tuning, while employing safeguards such as learning-rate scheduling and validation checks. As the models are refined with real-world usage data, the system further reduces recognition errors and improves the quality of sign language generation. This continuous improvement loop operates entirely within the computing infrastructure and optimizes the behavior of the underlying algorithms and data structures, further distinguishing the invention from manual or purely procedural human workflows.

Through these configurations, the server, the terminal, and the user collectively implement an end-to-end system in which audio information, prosodic feature quantities, and prompt sentences are processed in a coordinated pipeline. The system leverages specific data structures, machine learning architectures, and signal processing techniques to improve recognition accuracy, generation quality, computational efficiency, and real-time rendering performance. As a result, the system does not merely automate human sign interpretation, but instead enhances the technical capabilities of computer systems for multimodal communication and three-dimensional avatar control.

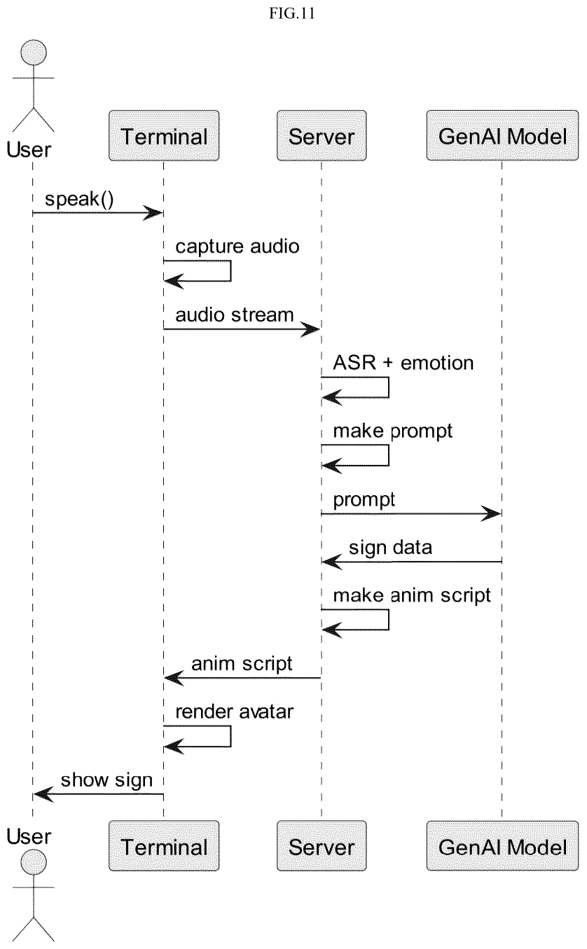

The following describes the processing flow using FIG. 11.

### Step 1:

The user speaks toward the microphone of the terminal and produces spoken utterances as analog sound waves.

The terminal receives the analog sound as input, uses an audio driver to sample the sound at a fixed sampling rate (for example, 16 kHz), and converts it into digital audio data in PCM format. The terminal applies automatic gain control and noise suppression to the PCM frames to reduce background noise and normalize volume. The terminal outputs a continuous stream of pre-processed audio packets, each packet containing a defined time window (for example, 20 ms) of PCM samples with a timestamp.

### Step 2:

The terminal takes the audio packets from Step 1 as input. The terminal opens a secure communication channel to the server, for example using HTTPS or WebSocket over TLS, and segments the audio stream into transmission units with sequence numbers. The terminal performs optional compression of the audio packets using an audio codec and adds metadata such as sampling rate and channel count. The terminal outputs a network data stream consisting of ordered, timestamped audio packets and transmits this stream to the server.

### Step 3:

The server receives the network data stream of audio packets from the terminal as input. The server reassembles the packets into a continuous audio buffer according to sequence numbers and timestamps, and decodes any compressed frames back into normalized PCM format. The server performs digital signal processing such as resampling to a standard rate, channel conversion to mono, and volume normalization. The server outputs a clean, continuous PCM audio buffer that is suitable for both speech recognition and emotion analysis.

### Step 4:

The server uses the normalized PCM audio buffer from Step 3 as input for speech recognition. The server computes acoustic feature vectors, for example Mel-frequency cepstral coefficients and filter bank energies, for short overlapping frames. The server feeds these feature vectors into an acoustic model implemented as a deep neural network and combines the resulting phonetic probability distributions with a language model using beam search decoding. The server also consults a domain-specific dictionary to adjust scores for technical terms. By computing and combining these probabilities, the server outputs character information as a text string that represents the most likely transcription of the spoken utterance.

### Step 5:

The server uses the same normalized PCM audio buffer from Step 3 as input for emotion recognition. The server extracts prosodic feature quantities, including fundamental frequency contours, energy profiles, speaking rate estimates, and pause durations, by analyzing the waveform and its spectrum over time windows. The server aggregates these features into temporal feature sequences and normalizes them using stored user-specific baseline statistics if available. The server feeds the normalized sequences into a trained neural network classifier, such as a recurrent or Transformer-based model, and computes class probabilities for emotion categories. On the basis of these probabilities, the server outputs emotion information that includes an emotion label, such as joy or sadness, and an associated intensity score.

### Step 6:

The server takes the character information from Step 4 and the emotion information from Step 5 as input. The server performs linguistic analysis on the character information using tokenization, part-of-speech tagging, and syntactic parsing to obtain grammatical roles and sentence structure. The server applies rule-based transformations to reorder tokens, remove unnecessary function words, and insert placeholders for non-manual behaviors in accordance with target sign language grammar. The server modulates these placeholders using the emotion label and intensity, for example by tagging specific sign units as emphasized when emotion intensity exceeds a threshold. The server outputs a sign language intermediate representation that encodes a sequence of sign units, grammatical annotations, non-manual markers, and a target sign language type.

### Step 7:

The server takes the sign language intermediate representation from Step 6 and the emotion information from Step 5 as input. The server selects a target sign language type based on configuration or user profile and constructs a prompt sentence that explicitly instructs a generative AI model to produce structured sign language expression data. The server embeds the intermediate representation, the emotion information, and the sign language type as textual content and constraints in the prompt sentence. For example, the server generates a prompt sentence such as:

“Translate the following sentence into sign language gloss. Include detailed instructions for facial expressions and movement size. The overall emotion is joy. Sentence: ‘We just exceeded our quarterly target by 50 percent.’”

Using this textual assembly, the server outputs a complete prompt sentence ready to be sent to the generative AI model.

### Step 8:

The server uses the prompt sentence from Step 7 as input to the generative AI model. The server sends the prompt sentence through an API call to the model, which is implemented as a neural sequence-to-sequence architecture, for example a Transformer network. The model encodes the prompt text into internal vector representations, applies self-attention layers to capture contextual relations, and decodes a structured sign language description token by token. The server receives the model's output, which consists of sign language expression data containing gloss sequences, hand shapes, positions, movement types, durations, and facial expression tags. The server parses the textual output into a structured internal data format and validates that each sign element includes required attributes. The server outputs structured sign language expression data suitable for motion mapping.

### Step 9:

The server takes the structured sign language expression data from Step 8 as input. The server accesses a motion dictionary that maps sign units and movement tags to motion primitives, such as joint angle curves and facial expression curves stored in a motion library. For each sign unit, the server retrieves the corresponding motion primitive and scales movement amplitude, duration, and facial blendshape magnitudes based on the emotion information and non-manual behavior intensity. The server arranges these primitives on a continuous time axis, computes transition blends between adjacent motions, and interpolates intermediate keyframes to ensure smooth animation. The server outputs an animation script that contains skeletal information, time-varying joint angle data, and time-varying facial expression parameters.

### Step 10:

The server uses the animation script from Step 9 as input for network transmission. The server optionally compresses the script using a lossless compression algorithm and adds metadata such as frame rate, avatar rig version, and language type. The server encapsulates the compressed script in a response message and sends it via the communication module over the secure channel to the terminal. The server outputs a network payload that carries the animation script and associated metadata to the terminal.

### Step 11:

The terminal receives the network payload containing the animation script from Step 10 as input. The terminal decompresses the payload if necessary and parses the animation script into an internal data structure, mapping logical joint identifiers and facial parameter names to the corresponding elements in the local avatar rig. The terminal verifies compatibility between the script metadata and the stored avatar model and loads or selects the appropriate three-dimensional character asset. The terminal outputs a prepared animation control structure that is ready to drive the avatar's skeleton and facial expressions.

### Step 12:

The terminal uses the prepared animation control structure from Step 11 and the locally stored user settings as input. The terminal adjusts timing parameters, motion amplitude, and facial expression intensity according to user preferences, for example scaling keyframe times to slow down or speed up signing and scaling joint angles to increase or decrease gesture size. The terminal feeds the resulting joint and facial parameters frame by frame to a three-dimensional graphics engine, which computes mesh deformation, lighting, and rendering. The terminal outputs real-time visual frames on the display, showing a virtual person performing sign language with movements and expressions that reflect both the original spoken content and the detected emotion, customized according to the user's settings.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional sign-language support systems that convert speech into visual expressions typically rely on static phrase dictionaries, manually authored rule sets, or pre-recorded animation clips. Such systems often treat speech recognition, emotion detection, sign-language generation, and avatar animation as loosely coupled or independent components. As a result, these systems exhibit multiple technical drawbacks in terms of computer technology.

First, conventional systems have limited ability to adapt to diverse linguistic content and user-specific emotional nuances. Because they depend on fixed mappings between recognized text and sign-language expressions, they cannot flexibly generate sign-language sequences for previously unseen phrases or domain-specific terminology. This limitation forces designers to expand dictionaries and rule sets manually, which is computationally inefficient and does not scale in runtime performance when handling varied and evolving input speech.

Second, many existing systems inadequately exploit prosodic features of audio signals. They frequently ignore detailed prosodic feature quantities such as fundamental frequency contours, duration patterns, intensity changes, and pauses, or they use them only in a heuristic manner. As a result, the systems are computationally suboptimal in that they do not fully utilize available signal information to derive a rich, machine-usable representation of emotion. This leads to a mismatch between the underlying audio characteristics and the generated visual output, reducing the effectiveness of the human-computer interaction.

Third, typical animation pipelines apply generic motion clips without fine-grained, data-driven control informed by both recognized content and emotion. In such pipelines, motion patterns for sign-language units and non-manual elements (such as facial expressions and head movements) are combined in a rigid or pre-defined manner. This causes inefficiencies in animation synthesis: a large number of clips must be stored and managed, blending between clips is often coarse, and continuous, emotion-dependent parameter control (e.g., speed, amplitude, facial-expression intensity) is not well supported. Consequently, the computing resources of the animation engine—such as memory usage, processing cycles, and interpolation logic—are not utilized in an optimal and integrated way.

Fourth, prior systems do not provide a unified computational mechanism that translates heterogeneous intermediate representations (recognized text, prosodic features, emotion labels) into a single, generative AI-oriented prompt format and then back into low-level animation parameters. Without such a unified mechanism, application software must implement multiple bespoke transformation layers, increasing implementation complexity, processing latency, and error propagation. The absence of a standardized generation input sentence (prompt sentence) for a generative AI model also prevents the reuse of advanced sequence modeling capabilities provided by modern machine-learning models.

Thus, there is a need for an improved computer-implemented system that (i) jointly processes audio signals, textual representations, and prosodic features to obtain detailed emotion information; (ii) constructs a structured, natural-language prompt sentence combining recognized content, emotion, target sign-language type, output format, and motion-style instructions; (iii) leverages a generative AI model to produce symbolic sign-language and non-manual information; and (iv) systematically converts that symbolic information into optimized skeletal and facial motion information for driving a three-dimensional avatar. Such a system should improve the efficiency, scalability, and fidelity of the entire processing pipeline—from audio acquisition to avatar animation—thereby constituting a technical improvement in computer-based human-machine communication and animation generation.

The specific processing by the specific processing unit 290 of the data processing device 12 in Application Example 1 is realized by the following means.

The present invention provides a server comprising a processor configured to acquire audio information, generate character information based on the audio information, extract prosodic information from the audio information and identify emotion information, construct a generation input sentence based on the character information and the emotion information, input the generation input sentence to a generative information processing model to generate symbolic information including sign-language information and non-manual information, convert the symbolic information into motion information including skeletal information and facial-expression information, and generate animation information that defines time-series postures of body parts and facial parts of a three-dimensional display target based on the motion information and cause a visual expression to be displayed using the animation information. This enables a unified and computer-implemented processing pipeline in which audio signals are transformed, through a generative AI-based prompt mechanism, into emotion-sensitive symbolic sign-language representations and then into optimized low-level motion parameters, thereby improving the technical performance, flexibility, and expressiveness of speech-to-avatar animation conversion in a computing environment.

The term “audio information” refers to digital data representing sound signals obtained from an audio sensor or similar input device, including but not limited to sampled waveforms, encoded audio streams, and pre-processed audio frames.

The term “character information” refers to symbolic textual data derived from audio information, including sequences of characters, words, or tokens that represent linguistic content recognized from speech.

The term “prosodic information” refers to feature quantities derived from temporal patterns in audio information, including at least fundamental frequency contours, duration patterns, intensity variations, and pause structures that characterize how an utterance is spoken.

The term “emotion information” refers to one or more labels, scores, or feature sets indicating an emotional state associated with audio information, obtained by analyzing prosodic information or related acoustic features using computational methods.

The term “generation input sentence” refers to a structured natural-language sequence that combines character information, emotion information, and one or more control parameters, and that is intended to be used as input to a generative AI model.

The term “prompt sentence” refers to a particular instance of a generation input sentence formatted as a natural-language instruction to a generative AI model, specifying desired output content, style, and structure.

The term “generative information processing model” refers to a computational model, typically implemented as a machine-learning or deep-learning model, configured to generate new symbolic or numerical data in response to input data, including but not limited to large language models and multimodal generative models.

The term “symbolic information” refers to structured data composed of discrete symbols representing sign-language units and non-manual elements, including glosses, markers, and annotations that can be interpreted by a computer for further processing.

The term “sign-language information” refers to symbolic data describing manual components of sign language, including hand shapes, hand trajectories, orientations, and relative positions corresponding to linguistic units.

The term “non-manual information” refers to symbolic data describing non-manual components associated with sign language, including facial expressions, head movements, eye gaze, and body posture cues.

The term “motion information” refers to numerical or symbolic data specifying movement parameters for a graphical or physical representation, including joint rotations, translations, timing values, and intensity levels for body parts and facial elements.

The term “skeletal information” refers to motion information associated with a hierarchical structure of interconnected joints or bones used to define body movements of a graphical model or avatar.

The term “facial-expression information” refers to motion information associated with control points, blendshapes, or parameters that define changes in a facial model to express different emotional or linguistic states.

The term “animation information” refers to time-series data that defines changes in pose, position, or configuration of a graphical model over time, including sequences of keyframes, interpolation parameters, and associated metadata for visual playback.

The term “time-series postures” refers to a temporally ordered set of body and facial configurations that describe successive poses of a model at discrete or continuous time points.

The term “three-dimensional display target” refers to a virtual object or avatar represented within a three-dimensional coordinate system and rendered on a display device, whose appearance and motion can be controlled programmatically.

The term “visual expression” refers to an output presented on a display device that conveys information through graphical elements, including animated avatars, gestures, and facial expressions generated from animation information.

The term “motion elements” refers to predefined motion units or primitives stored in a memory, each representing a reusable pattern of movement for parts of a model, such as specific sign-language gestures or facial actions.

The term “motion patterns” refers to sequences or combinations of motion elements that define a complete movement or gesture, including its temporal structure and parameter values.

The term “sign-language units” refers to discrete components of sign language, including lexical signs, classifiers, or other manual symbols that carry linguistic meaning.

The term “non-manual elements” refers to discrete components of non-manual behavior associated with sign language, including specific facial expressions, head nods, eye movements, and body shifts that modify or complement manual signs.

The term “target sign-language type” refers to an identifier or descriptor indicating which sign-language system or variant is to be used by the generative AI model, such as a regional or national sign-language convention.

The term “output format” refers to a specification of the structural form and encoding of data to be generated by the generative AI model, including but not limited to JSON, XML, or custom schema definitions.

The term “motion-style instructions” refers to directives included in a generation input sentence that indicate desired characteristics of generated motion, such as speed, smoothness, amplitude, and expressiveness, often dependent on emotion information.

The term “virtual person” refers to a computer-generated character or avatar rendered on a display device, which is controlled by animation information to simulate human-like appearance and behavior.

In one embodiment, a server, a terminal, and a user cooperate to implement the claimed system. The server includes at least one processor, a non-transitory memory, and a network interface. The terminal includes at least one processor, a microphone, a display device, and a network interface. The user operates the terminal and provides speech input. The server executes a plurality of software modules including a speech recognition module, an emotion identification module, a prompt construction module, a generative AI interaction module, a symbolic-to-motion conversion module, and an animation generation module. The terminal executes an audio acquisition module and an avatar rendering module.

The terminal uses hardware such as a smartphone, a tablet, a notebook computer, a wearable device, or an earphone-type device, and uses software such as an operating system audio API (for example, an audio capture application programming interface corresponding to AudioRecord or an audio engine corresponding to AVAudioEngine) to acquire analog speech from the user via the microphone. The terminal converts the analog speech into digital audio data, for example 16-bit linear pulse-code modulated samples at 16 kHz, and stores the samples in a buffer in a memory. The terminal applies noise reduction using an audio processing library corresponding to a real-time communication audio processing module, which performs spectral subtraction, automatic gain control, and echo cancellation to generate cleaned audio frames. The terminal segments the cleaned audio into fixed-length frames and associates each frame with metadata including timestamps, speaker identifier, and session identifier. The terminal then transmits the frames to the server using a communication protocol such as a transport-layer streaming protocol implemented by a network library corresponding to a web-socket or an HTTP-based client.

The server receives the digital audio frames from the terminal at a network interface and stores them into an input buffer managed by an audio pre-processing component. The server uses a digital signal processing library corresponding to Librosa or a similar feature extraction library to compute acoustic features. The server computes, for each short-time window, log-Mel filterbank energies or Mel-frequency cepstral coefficients. The server normalizes amplitudes over time to reduce variability caused by distance from the microphone and device-specific characteristics. The server stores the resulting feature vectors in a structured data array in the memory, such as a multi-dimensional tensor, and provides references to the speech recognition module and to the emotion identification module. The server implements the speech recognition module using an automatic speech recognition engine based on a deep neural network. In one embodiment, the server uses a neural network architecture of a sequence-to-sequence model with an encoder and a decoder. The server configures the encoder as a stack of recurrent layers or transformer layers that receive the acoustic feature vectors and produce a sequence of high-level hidden representations. The server configures the decoder as a recurrent or transformer-based network with an attention mechanism that outputs symbol probabilities for characters, subword units, or phoneme-like units. The server uses a language model that is trained on domain-specific text, wherein the language model is a recurrent neural network or a transformer language model. The server combines an acoustic model and a language model using a beam search decoding procedure that maintains multiple candidate hypotheses and selects a final character string corresponding to the highest combined probability. The server thereby generates character information, which is a sequence of characters or tokens representing the recognized utterance. The server optionally uses a domain-specific dictionary stored in a database to bias decoding toward terms related to care environments, such as medical terms and routine instructions.

The server concurrently implements the emotion identification module. The server computes prosodic information using the same or additional audio pre-processing routines. The server calculates fundamental frequency contours using an autocorrelation method or a cepstral method, and extracts intensity envelopes using energy measures. The server measures pause durations by detecting intervals where the short-time energy falls below a threshold. The server forms a feature vector sequence containing, for each frame, fundamental frequency, intensity, spectral tilt, speaking rate estimates, and pause indicators. The server inputs these feature vectors into a neural network classifier constructed as a bidirectional recurrent network or a transformer encoder. The server trains this classifier beforehand using supervised learning on a labeled emotional speech corpus. During training, the server uses a cross-entropy loss function between predicted emotion class probabilities and reference labels, performs gradient descent optimization such as stochastic gradient descent with momentum or an adaptive method, and updates network weights until convergence. The server may apply data augmentation to the training data by randomly shifting pitch or adding synthetic noise to improve robustness. At runtime, the server computes a probability distribution over emotion classes such as reassuring, warning, joyful, or surprised and selects the class with the maximum probability as the emotion information.

The server constructs a generation input sentence by combining the character information and the emotion information along with control parameters. The server uses a template engine implemented by a string-processing library. The server fills template slots with the recognized text, the identified emotion, a target sign-language type, an output format specification, and motion-style instructions. The server thereby constructs a prompt sentence that is a natural-language instruction to a generative AI model. For example, the server can generate the following prompt sentence:

“The sentence is: ‘We will take your blood pressure after lunch, so please relax.’

Please translate this sentence into Japanese Sign Language. The emotion is reassuring.

Output a detailed sequence of sign language glosses, non-manual markers (facial expressions, head movements), and timing suitable for driving a 3D avatar animation. Use calm, gentle movements and a soft facial expression.”

In another example, the server can generate:

“The sentence is: ‘It is time for your medication now.’

Please translate this sentence into Japanese Sign Language. The emotion is neutral.

Output a detailed sequence of glosses, handshapes, facial expressions, and timing information for a 3D avatar.”

In yet another example, the server can generate:

“The sentence is: ‘Be careful when standing up; the floor might be slippery.’

Please translate this sentence into sign language. The emotion is warning.

Use clear, slightly emphasized movements and serious facial expressions.

Output a machine-readable description suitable for real-time animation.”

The server provides the generation input sentence to a generative AI model. The server can host the generative AI model locally or connect to an external generative AI service through an application programming interface. In one embodiment, the server implements the generative AI model as a large-scale transformer-based language model with multiple layers of self-attention and feedforward sub-layers. The server represents the generation input sentence as a token sequence using a tokenizer such as a byte-pair encoding tokenizer. The server embeds each token into a vector space using a learned embedding matrix and adds positional encodings. The server propagates the embedded sequence through transformer blocks, where each block computes self-attention to model long-range dependencies and uses feedforward sub-networks to produce richer representations.

The server conditions the generation process on explicit control tokens or markers that reflect the target sign-language type and emotion. The server influences the model's output format by including textual instructions such as “Output a detailed sequence of sign language glosses, non-manual markers, and timing.” The server sets inference parameters such as temperature and top-k sampling to balance determinism and variation. The server then decodes the model output as symbolic information, which includes sequences of sign-language units described as glosses, together with non-manual elements including facial expression labels, head movement descriptions, eye gaze directions, and timing intervals. The server optionally constrains the output to a particular schema by post-processing and by rejecting outputs that do not conform to required structural patterns (for example, missing gloss or duration fields).

The server converts the symbolic information into motion information. The server stores, in a motion library, a plurality of motion elements corresponding to handshapes, arm trajectories, facial expressions, and body postures. Each motion element is encoded as joint rotation curves or blendshape weight curves over time, defined in the skeleton of an avatar model. The server maintains a mapping table that associates sign-language glosses and non-manual descriptors with motion elements. When the server receives symbolic information from the generative AI model, the server looks up corresponding motion elements and selects motion patterns that are appropriate for the target sign-language type.

The server concatenates selected motion elements into longer motion patterns according to the order and timing specified in the symbolic information. The server modifies the speed, amplitude, and facial-expression intensity of each motion pattern based on the emotion information. For example, when the emotion information indicates “reassuring,” the server scales the motion velocities downward, reduces abrupt acceleration, and increases the duration of gentle head nods and soft smiles. The server performs interpolation at boundaries between successive motion elements so that joint rotations and blendshape weights change smoothly without discontinuities. The server uses interpolation algorithms such as cubic spline interpolation or spherical linear interpolation for quaternions. The server thereby generates motion information that defines continuous joint trajectories and facial parameter curves.

The server encodes the motion information as animation information describing time-series postures for a three-dimensional display target. The server formats the animation information as a timeline of keyframes, each keyframe containing a timestamp and a vector of joint rotations and facial parameters. The server optionally stores the animation information in a standard container such as a three-dimensional graphics transmission format file, or transmits the animation information in a custom structure to the terminal. The server may reduce communication load by applying keyframe compression, for example by removing redundant frames or quantizing parameters while respecting a maximum allowed pose error threshold.

The terminal receives the animation information via the network interface and parses it in an avatar rendering module. The terminal maintains in memory a three-dimensional avatar model. This avatar model includes a skeletal rig with hierarchical joints for torso, arms, hands, head, and fingers, as well as a facial rig with blendshapes or bone-based controls. The terminal uses a graphics engine corresponding to a game or graphics engine to update the avatar's pose and facial expression according to the animation information. The terminal interpolates between keyframes on the client side to compensate for different display refresh rates, and the terminal renders each frame to the display using a three-dimensional renderer and a shading pipeline accelerated by a graphics processing unit.

The user views the avatar on the display and perceives sign-language gestures and non-manual expressions that correspond to the original speech content and emotion. The user may interact with the terminal to adjust avatar parameters, such as selecting different avatar appearances or adjusting motion speed. The terminal updates local configuration data to adapt subsequent animations to user preferences without changing the underlying server-side processing.

By using the described structure and processing flow, the server and the terminal achieve technical improvements over conventional systems. Because the server integrates prosodic feature extraction, emotion classification, prompt construction, and generative AI output into a single pipeline, the server reduces the need for manual dictionary expansion and rigid rule sets. The server and the generative AI model can generate sign-language sequences for previously unseen sentences, while the symbolic-to-motion mapping and interpolation reduce the quantity of stored motion clips required. The system thereby decreases memory consumption for animation assets and reduces network bandwidth for distributing new gestures.

Furthermore, the server employs specific neural network architectures and training methods to improve recognition and synthesis accuracy. By using a sequence-to-sequence speech recognizer with an attention mechanism and by training an emotion classifier with a dedicated loss function and data augmentation, the server increases robustness against background noise and speaker variability. The server achieves lower word error rates and higher emotion classification accuracy, which directly improves the quality of the generated prompt sentences and, consequently, the symbolic information produced by the generative AI model.

The server's prompt-based integration with the generative AI model is not a mere automation of human translation. The server encodes, in the generation input sentence, machine-oriented constraints and explicit motion-style instructions that are tailored to the downstream animation engine. These constraints include output format descriptions, timing granularity, and mapping hints that a human translator would not normally specify. The generative AI model produces symbolic output that is structured to facilitate algorithmic conversion into skeletal and facial parameters, and the server enforces compliance with this structure in post-processing. This non-conventional prompt-to-motion pipeline improves computational efficiency in transforming high-level language into low-level animation control signals.

Additionally, the server and the terminal cooperate to optimize runtime performance. The server offloads computationally intensive operations such as feature extraction, deep neural network inference, and generative AI decoding to high-performance computing hardware, such as multi-core processors and specialized accelerators. The terminal then performs only the final rendering operations, which are optimized for graphics hardware. This division of labor reduces latency perceived by the user and ensures that even resource-constrained terminals can display complex three-dimensional animations in real time.

In alternative embodiments, the server may employ different neural architectures, such as a connectionist temporal classification model for speech recognition or a convolutional-recurrent network for emotion identification. The generative AI model can be replaced by a smaller domain-specific generative model when memory or latency requirements are strict. The symbolic-to-motion conversion can also employ inverse kinematics solvers or motion retargeting algorithms to adapt motions to avatars with different skeletal structures. The core concept remains that the server constructs a generation input sentence combining character information and emotion information, uses a generative AI model to produce structured symbolic information, and converts that symbolic information into time-series motion for a three-dimensional avatar, thereby improving the technical operation of a computer-based speech-to-sign-language system.

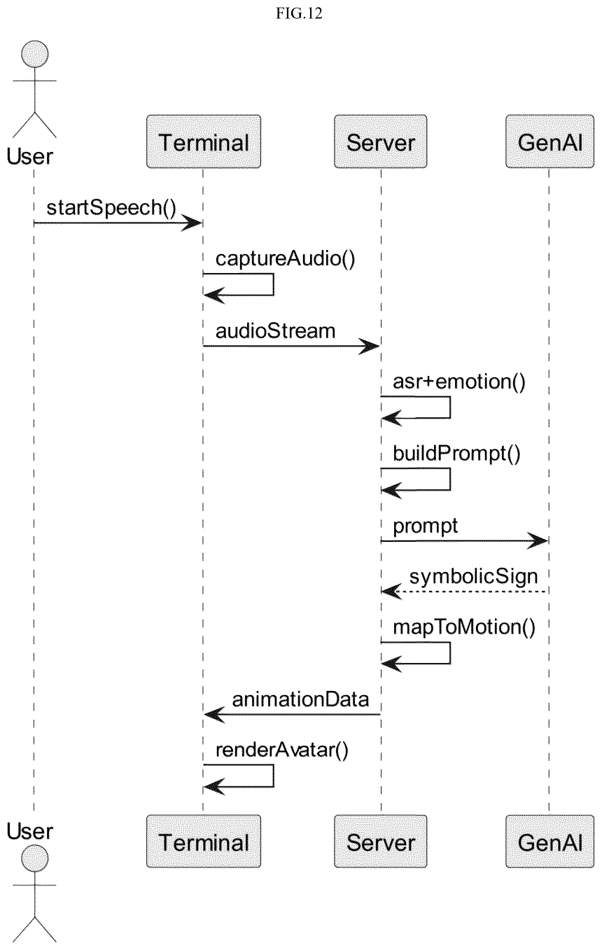

The following describes the processing flow using FIG. 12.

### Step 1:

The user operates the terminal to start audio capture.

The user presses a “Start” button on the terminal screen and begins speaking near the microphone.

Input: No prior digital data (only the user's spoken voice as an analog signal).

Output: A control signal to the terminal indicating that audio capture should begin, and a session identifier generated by the terminal.

### Step 2:

The terminal acquires raw audio data from the microphone.

The terminal uses an audio API to sample the analog speech signal at a fixed sampling rate (for example, 16 kHz, 16-bit PCM) and stores successive samples into an in-memory buffer.

Input: Analog speech signal and the control signal indicating capture is active.

Output: A continuous sequence of raw audio samples representing the user's utterance.

### Step 3:

The terminal pre-processes the raw audio samples to generate cleaned audio frames.

The terminal applies noise reduction using a signal-processing routine (for example, spectral subtraction and automatic gain control) and segments the normalized waveform into fixed-length frames (for example, 20-30 ms each), attaching a timestamp and the session identifier to each frame.

Input: Raw audio sample sequence.

Output: A sequence of cleaned, time-stamped audio frames ready for transmission.

### Step 4:

The terminal transmits the cleaned audio frames to the server.

The terminal opens a secure network channel (for example, a WebSocket or HTTP streaming connection) and serializes each audio frame together with its metadata into network packets, then sends the packets to the server in chronological order while monitoring for transmission errors.

Input: Cleaned, time-stamped audio frames and session identifier.

Output: A network data stream containing ordered audio frames delivered to the server.

### Step 5:

The server receives the audio stream and reconstructs the full audio signal.

The server accepts incoming packets at a network interface, verifies the session identifier, de-serializes each packet, and writes the audio samples into a session-specific buffer, reordering packets if necessary based on timestamps to reconstruct a continuous audio signal.

Input: Network packets containing cleaned audio frames and metadata.

Output: A continuous, ordered audio signal in a server-side buffer associated with the session.

### Step 6:

The server extracts acoustic features for speech recognition.

The server divides the buffered audio signal into overlapping analysis windows, computes spectral features such as log-Mel spectrograms or Mel-frequency cepstral coefficients, normalizes feature vectors across time (for example, mean-variance normalization), and stores the sequence of feature vectors in a tensor structure.

Input: Continuous, ordered audio signal.

Output: A time-ordered sequence of acoustic feature vectors for use by the speech recognition module.

### Step 7:

The server performs speech recognition to generate character information.

The server inputs the acoustic feature sequence into a deep neural network-based automatic speech recognition model (for example, an encoder-decoder or transformer model), uses an acoustic model to estimate symbol probabilities, combines these with a language model and a domain-specific dictionary using beam search decoding, and selects the most probable text sequence.

Input: Sequence of acoustic feature vectors.

Output: Character information representing the recognized utterance as a text string or token sequence.

### Step 8:

The server extracts prosodic features from the audio signal.

The server processes the same audio buffer to compute prosodic descriptors, such as fundamental frequency contour using pitch detection, short-time energy for intensity, duration of voiced segments, and pause intervals, and forms a feature-vector sequence capturing these temporal patterns.

Input: Continuous audio signal associated with the session.

Output: A time-aligned sequence of prosodic feature vectors describing pitch, intensity, and timing characteristics.

### Step 9:

The server identifies emotion information from the prosodic features.

The server inputs the prosodic feature sequence into a trained emotion-classification neural network (for example, a recurrent or transformer-based classifier), calculates class probabilities for each supported emotion label, and selects the emotion with the highest probability as the emotion information for the utterance.

Input: Sequence of prosodic feature vectors.

Output: Emotion information, including at least one emotion label (for example, reassuring, warning, joyful) and optionally confidence scores.

### Step 10:

The server constructs a generation input sentence (prompt sentence) using the character information and the emotion information.

The server inserts the recognized text, the identified emotion, a target sign-language type, and output-format and motion-style instructions into a template string, generating a natural-language instruction tailored for a generative AI model.

Input: Character information, emotion information, and configuration parameters (target sign-language type, output format, motion style).

Output: A prompt sentence that serves as a generation input sentence for the generative AI model.

### Step 11:

The server sends the prompt sentence to the generative AI model and generates symbolic information.

The server tokenizes the prompt sentence, submits the tokens to a transformer-based generative AI model, performs inference with specified decoding parameters (for example, temperature and top-k settings), and decodes the model output into symbolic information containing sign-language glosses, non-manual markers, and timing descriptions.

Input: Prompt sentence in natural-language form.

Output: Symbolic information including an ordered sequence of sign-language units and non-manual elements with associated timing and semantic annotations.

### Step 12:

The server maps the symbolic information to motion elements in a motion library.

The server analyzes each sign-language gloss and non-manual descriptor, performs a lookup in a pre-stored motion-element database to find corresponding motion primitives, and builds a list of selected motion elements aligned with the symbolic sequence.

Input: Symbolic information representing sign-language units and non-manual elements.

Output: A sequence of motion elements, each referencing a predefined joint-rotation or blendshape pattern corresponding to a symbolic unit.

### Step 13:

The server generates detailed motion information by adjusting and connecting motion elements.

The server modifies temporal parameters (speed, duration) and spatial parameters (amplitude, intensity) of each motion element based on the emotion information, then connects consecutive elements using interpolation (for example, spline interpolation for joint rotations), thereby producing continuous joint and facial parameter trajectories over time.

Input: Sequence of motion elements and emotion information.

Output: Motion information describing continuous trajectories for skeletal joints and facial-expression controls.

### Step 14:

The server encodes the motion information as animation information suitable for three-dimensional rendering.

The server samples the continuous motion trajectories at discrete time points to create keyframes, packages each keyframe with timestamps and parameter vectors into an animation timeline, and compresses the data if necessary to reduce size while preserving a specified maximum pose error.

Input: Continuous motion trajectories for body and facial components.

Output: Animation information comprising a time-series of keyframes for a three-dimensional avatar.

### Step 15:

The server transmits the animation information to the terminal.

The server serializes the animation timeline into a chosen data format, attaches the session identifier and metadata, and sends the serialized payload over the network connection to the terminal, confirming successful delivery or re-sending segments in case of transmission failures.

Input: Animation information and session metadata.

Output: A network payload containing animation information received by the terminal.

### Step 16:

The terminal receives and parses the animation information.

The terminal reads the incoming payload from the network interface, verifies the session identifier, de-serializes the animation data into an internal structure (for example, a list of keyframes with joint and facial parameters), and stores the result in a rendering buffer associated with the avatar.

Input: Serialized animation payload from the server.

Output: Parsed animation information ready for application to the local avatar model.

### Step 17:

The terminal applies the animation information to a three-dimensional avatar model and renders the visual expression.

The terminal loads a three-dimensional avatar with a skeletal rig and facial controls, applies joint rotations and facial parameters from each keyframe at the corresponding timestamps using a graphics engine, interpolates between keyframes to match the display refresh rate, and outputs the resulting animated frames to the display device.

Input: Parsed animation information and the local three-dimensional avatar model.

Output: A continuous visual expression on the display, showing sign-language gestures and non-manual expressions corresponding to the user's original speech and emotion.

### Step 18:

The user observes the rendered avatar and optionally adjusts interaction settings.

The user watches the avatar performing sign language, checks whether the displayed gestures and expressions are comprehensible and comfortable, and may operate settings controls on the terminal to modify avatar appearance or playback speed, causing the terminal to update local configuration parameters used in future rendering operations.

Input: Visual display output and user preferences for avatar behavior.

Output: Updated user configuration data stored on the terminal and improved usability for subsequent sessions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional sign language presentation systems that convert spoken language into sign language animations generally focus on mapping recognized text to preauthored motion sequences. In these systems, a processing device typically performs automatic speech recognition on incoming audio, then applies a fixed rule set or static dictionary to select corresponding sign units and associated avatar motions. While such systems can convey the literal content of speech, they suffer from several technical limitations that degrade the effectiveness, adaptability, and efficiency of computer-based sign language presentation.

First, existing systems generally treat emotion as a simple attribute of the speaker, if they consider emotion at all. Even when a speaker emotional state is estimated from prosodic features, the system often uses a small set of coarse styles or fixed visual effects that are applied uniformly to all sign outputs. The processing pipeline is not configured to incorporate the real-time emotional and cognitive state of the viewer, such as confusion, anxiety, boredom, or high engagement, into the generation of sign language animations. As a result, the avatar motion parameters (sign speed, motion amplitude, repetition count, and facial expression intensity) remain largely static or only loosely reactive, and the computer system cannot adapt its output to the viewer's current understanding and attention state in a fine-grained manner.

Second, conventional sign language generation architectures are usually rule-based or template-based and require extensive manual authoring of motion templates and heuristics. This leads to rigid behavior and poor scalability. The processing device must store large, handcrafted rule sets to handle different sentence structures and stylistic variations, which makes maintenance and extension difficult. Moreover, because the rule system is not optimized for rich multi-parameter control, attempts to adjust speed, emphasis, or nuance based on emotion tend to introduce inconsistencies or timing artifacts in the resulting motion data, thereby lowering the fidelity and smoothness of the animation.

Third, in many known systems, the input to any high-level generative component is narrowly defined and does not explicitly encode a structured, machine-controllable description of how the sign language should be varied according to both speaker and viewer states. For instance, the system may provide only the transcribed text and a single emotion label to a back-end model, without explicit instructions regarding which key terms to emphasize, how many times to repeat a motion, or how to modulate non-manual signals such as facial expressions and body posture. This under-specification constrains the ability of the computational model to generate sign language outputs that are both context-sensitive and systematically controllable by the surrounding system logic, causing a mismatch between the system's internal adaptive logic and the generative subsystem.

Fourth, current systems often do not exploit multimodal user state sensing in a unified computational pipeline. Although face images, interaction logs, and biometric data might be available via modern terminal devices, typical sign language systems either ignore these data or process them in isolation. They do not employ a processor configured to integrate facial expression features, user interface operation patterns, and physiological signals into a coherent viewer emotional state estimate, nor do they feed that estimate back into the sign generation process in a structured way. Consequently, the computer system does not dynamically tune sign speed, repetition, or expressiveness in response to observable signs of confusion, stress, or disengagement, leading to suboptimal user comprehension and interaction quality.

Fifth, the mapping from high-level sign descriptions to low-level avatar motion is frequently realized by simple lookups that do not support parameterized reuse of standard motion segments. In such architectures, if different emphasis levels or speeds are needed, new motion clips must be authored and stored, which increases storage requirements and reduces flexibility. The processing pipeline is not architected to programmatically adjust time length, motion amplitude, and repetition count of reusable motion units based on structured instructions received from an upstream model. This limits the ability of the computer system to perform efficient, real-time synthesis of varied sign language animations on resource-constrained devices.

Accordingly, there is a need for a computer-implemented system that improves the internal information processing architecture for sign language presentation by (i) jointly analyzing digital sound information and multimodal user state information, (ii) generating a structured prompt sentence that encodes both speaker and viewer emotional states together with explicit motion control instructions, (iii) leveraging a generative artificial intelligence model to obtain sign language expression data responsive to that rich prompt, and (iv) translating such expression data into parameterized, reusable avatar motions. Such a system should allow a processor to more efficiently and adaptively control sign language animation generation, improve the alignment between linguistic content and emotional nuance, and enhance overall computational effectiveness and resource utilization in real-time, networked environments.

The specific processing by the specific processing unit 290 of the data processing device 12 in Example 2 is realized by the following means.

The present invention provides a server comprising a processor configured to acquire digital sound information from an acoustic sensor of a terminal device, perform acoustic analysis and linguistic analysis on the digital sound information to generate character information, extract sound feature information including prosodic features from the digital sound information to identify a speaker emotional state, acquire user state information including at least part of face image information, operation history information, and biological information of a viewer, identify a viewer emotional state of the viewer based on the user state information, generate a prompt sentence for a generative artificial intelligence model based on the character information, the speaker emotional state, and the viewer emotional state, the prompt sentence explicitly including instruction content specifying at least one of sign speed, motion magnitude, repetition count, and expression intensity, input the prompt sentence to the generative artificial intelligence model to obtain sign language expression data including a sequence of sign units or intermediate representation data, refer to motion information storage in which standard motion clips are stored in association with the sign units, adjust at least one of time length, motion amplitude, and repetition count of the standard motion clips based on the instruction content included in or derived from the sign language expression data, and generate skeletal motion data and facial motion data of a virtual person image by connecting the adjusted standard motion clips on a time axis, so that sign language animation based on the skeletal motion data and the facial motion data is output to the terminal device through a communication network. This enables the computer system to dynamically co-optimize speech recognition, emotion estimation, generative sign synthesis, and motion parametrization in a single processing pipeline, thereby improving the technical performance of sign language animation generation, including adaptability to viewer state, efficient reuse of motion resources, and real-time responsiveness in distributed computing environments.

The term “digital sound information” refers to data representing sound as discrete numerical values obtained by sampling an electrical signal from an acoustic sensor at a predetermined sampling rate and quantization resolution.

The term “acoustic sensor” refers to a hardware element configured to convert sound waves in a physical environment into an electrical signal that can be further processed by an electronic apparatus.

The term “character information” refers to symbolic data representing linguistic content of speech in a written or coded form, including sequences of characters, letters, ideograms, or other textual units output by a recognition process.

The term “acoustic analysis” refers to processing that derives features from digital sound information, including at least one of time-domain and frequency-domain analysis, for use in speech recognition or emotion estimation.

The term “linguistic analysis” refers to processing that interprets acoustic analysis results and maps them to language units such as phonemes, subword units, words, or sentences using language models or linguistic rules.

The term “sound feature information” refers to numerical descriptors extracted from digital sound information, including at least one of prosodic features, spectral features, energy-related features, and temporal features.

The term “prosodic features” refers to features relating to suprasegmental aspects of speech, including at least one of pitch contour, intensity contour, duration, rhythm, speaking rate, and pause patterns.

The term “speaker emotional state” refers to an estimated emotional condition of a person who produced speech, categorized or quantified based on analysis of sound feature information.

The term “user state information” refers to data describing a condition of a viewer of sign language, including at least one of face image information, operation history information, and biological information.

The term “face image information” refers to image data including at least a region corresponding to a face of a viewer, captured by an image acquisition device and optionally preprocessed by detection or cropping.

The term “operation history information” refers to data indicating interactions of a viewer with a user interface, including at least one of touch events, pointer events, button activations, scrolling operations, and temporal patterns thereof.

The term “biological information” refers to data corresponding to physiological measurements of a viewer, including at least one of heart rate, heart rate variability, respiratory information, and other vital sign indicators.

The term “viewer emotional state” refers to an estimated emotional or cognitive condition of a viewer, categorized or quantified based on analysis of user state information including facial, behavioral, and physiological features.

The term “prompt sentence” refers to natural language text or an equivalent expression that encodes instructions and context information, including at least character information, speaker emotional state, viewer emotional state, and motion control directives, and that is provided as input to a generative artificial intelligence model.

The term “instruction content” refers to information included in or associated with a prompt sentence that specifies control parameters for generated sign language, including at least one of sign speed, motion magnitude, repetition count, and expression intensity.

The term “generative artificial intelligence model” refers to a machine learning model that has been trained on data to produce new data samples, including at least text data or intermediate representation data, in response to an input prompt sentence.

The term “sign language expression data” refers to data describing a sign language representation of an input utterance, including at least one of a sequence of sign units, linguistic glosses, motion annotations, and intermediate representation data suitable for conversion into avatar motion.

The term “sign unit” refers to a minimal or atomic element in a sign language representation, including at least one of a sign word, sign morpheme, classifier sign, or fixed gesture pattern.

The term “motion information storage” refers to a memory structure or database that stores motion data elements, including at least standard motion clips, each associated with one or more sign units.

The term “standard motion clip” refers to a reusable motion segment describing joint movements and optionally facial changes for a canonical performance of a corresponding sign unit.

The term “time length” refers to a temporal duration of playback of a motion clip or sequence of motion data in an animation.

The term “motion amplitude” refers to a quantitative measure of spatial extent or intensity of movement in motion data, including at least displacement of joints, angle ranges, or scaling factors applied to such movement.

The term “repetition count” refers to a numerical value indicating how many times a particular motion or sign unit is to be repeated in a sign language animation sequence.

The term “skeletal motion data” refers to data defining time-varying transformations of joints or bones of a virtual person image, including at least joint positions, rotations, or other parameters used to control a skeleton rig.

The term “facial motion data” refers to data defining time-varying changes of facial features of a virtual person image, including at least blendshape weights, bone transformations, or other control parameters for facial expressions.

The term “virtual person image” refers to a graphical representation of a human-like figure, implemented as a two-dimensional or three-dimensional model, that can be animated using skeletal motion data and facial motion data.

The term “sign language animation” refers to a time-varying visual presentation in which a virtual person image performs movements and expressions corresponding to sign language, based on skeletal motion data and facial motion data.

The term “terminal device” refers to an electronic device operated by a viewer, including at least a processing unit, an acoustic sensor, a display apparatus, and a communication interface, used for sending input data and presenting sign language animation.

The term “information processing device” refers to an electronic apparatus that executes software or logic to perform at least one of speech recognition, emotion identification, prompt generation, sign language generation, and motion synthesis.

The term “communication network” refers to a wired or wireless data transmission infrastructure that enables exchange of information between a terminal device and an information processing device.

In one or more embodiments, server, terminal, and user cooperate to implement the claimed system. The following description illustrates exemplary configurations and operations that enable a person skilled in the art to implement the invention. The described embodiments support and exemplify the scope of the claims and are not limiting.

Server, terminal, and user each operate as physical entities. Terminal includes at least a processor, a memory, a storage unit, an acoustic sensor such as a microphone, an image acquisition device such as a camera, a display device, a user input interface such as a touch panel, and a communication interface such as a wireless or wired network interface. Server includes at least a processor, a memory, a storage unit, and a network interface. User operates terminal and visually perceives sign language animation displayed on the display device.

Terminal executes an application program that includes modules implemented using an operating system and middleware. Terminal uses an audio input application programming interface provided by the operating system, such as an audio capture interface available in general-purpose mobile operating systems, to acquire sound information from the acoustic sensor. Terminal converts analog sound signals into digital sound information represented as pulse-code-modulated sampling values. Terminal uses a noise reduction library, such as a software component that implements spectral subtraction or recurrent neural network based noise suppression, to suppress background noise from the digital sound information and thereby improve signal-to-noise ratio before transmission to server.

Terminal uses a camera control interface, such as a video capture framework, to acquire face image information of user. Terminal performs simplified face detection, for example by applying a cascade classifier or a convolutional neural network based detector, to identify a facial region. Terminal crops the input image to the facial region, downsamples the image to a lower resolution and compresses the cropped image to a compressed image format such as a baseline still-image format. Terminal thereby reduces the amount of data transmitted to server while preserving facial expression information required for emotion estimation.

Terminal acquires operation history information by using event handling functions of a user interface framework. Terminal logs user interactions with on-screen components, including button activations, taps, scrolls, and swipes, together with timestamps and positions. Terminal computes interaction statistics, such as tap frequency and cumulative scroll distance over a given time window.

Terminal acquires biological information from an external sensing device, such as a wearable device, through a short-range communication protocol. Terminal receives heart rate, heart rate variability, and similar physiological signals through a health data interface and calculates statistical measures such as average heart rate and variability index.

Terminal combines digital sound information, compressed face image information, interaction statistics, and biological statistics into a structured user state information object, for example represented as a tree-structured text format. Terminal transmits the user state information to server via a secure communication protocol using the communication interface.

Server executes a web application framework on its processor to receive user state information transmitted from terminal. Server parses received data, extracts digital sound information and user state information elements, and stores them temporarily in memory.

Server performs acoustic analysis on digital sound information by segmenting the sound into frames and computing acoustic features such as filter bank energies and cepstral coefficients using a signal processing library.

Server performs linguistic analysis by applying an automatic speech recognition engine. Server can use a toolkit that implements an end-to-end neural network based speech recognition model, such as a hybrid model that combines an acoustic model and a language model, or an encoder-decoder architecture with an attention or transducer mechanism. Server loads trained network weights into memory and executes inference on a general-purpose processor or on a graphics processing unit. Server inputs acoustic features into the acoustic encoder, obtains latent representations, and then decodes these representations into subword units or characters using a beam search decoder and a statistical or neural language model. Server outputs character information as recognized text corresponding to the original spoken utterance.

Server performs speaker emotion identification by extracting sound feature information, including prosodic features, from digital sound information. Server uses a signal processing library to compute pitch contours, energy trajectories, speaking rate, and silence duration. Server concatenates these features into a time-series feature tensor. Server inputs this tensor into a trained neural network, for example a network including convolutional layers followed by bidirectional recurrent layers and fully connected layers. Server computes activation values and probability outputs for a predefined set of emotion classes such as neutral, joy, anger, sadness, and surprise. Server uses a loss function, such as categorical cross-entropy, during training to optimize network weights based on labeled training data. During operation, server compares output probabilities and selects a class with highest probability as the speaker emotional state. Because server computes emotion from fine-grained acoustic features and uses a deep architecture that captures temporal context, the system achieves improved robustness and accuracy compared to shallow or rule-based classifiers.

Server performs viewer emotion identification by analyzing user state information including face image information, operation history information, and biological information. Server applies an image processing library to detect facial landmarks such as eyes, eyebrows, nose, and mouth. Server computes facial expression features including metrics like eyebrow elevation, eyelid openness, and mouth curvature. Server converts interaction statistics into a behavioral feature vector, and converts biological statistics into a physiological feature vector. Server concatenates facial, behavioral, and physiological vectors into a multimodal feature representation.

Server inputs this multimodal representation into a multimodal neural network implemented in a machine learning framework. In one embodiment, server uses separate subnetworks, such as convolutional layers for image features and dense or recurrent layers for behavioral and physiological features, and then fuses their outputs in a joint representation layer. Server trains the multimodal network using labeled datasets where viewer emotional states, such as understanding, confusion, interest, boredom, anxiety, and relief, are annotated. Server uses a loss function to minimize classification error and updates network weights using gradient-based optimization such as stochastic gradient descent or an adaptive optimizer. During runtime, server computes class probabilities and selects the highest probability as the viewer emotional state. By integrating multiple modalities, server increases reliability and reduces error associated with relying on a single feature source.

Server generates a prompt sentence for a generative AI model based on character information, the speaker emotional state, and the viewer emotional state. Server identifies important terms in the recognized text by applying a term extraction algorithm, such as keyword extraction using part-of-speech tagging or attention-based importance scoring. Server constructs instruction content that specifies sign speed, motion magnitude, repetition count, and expression intensity according to rules or learned mappings from emotion combinations to motion parameters. For example, when the speaker emotional state is neutral and the viewer emotional state is confused, server determines that sign speed should be slow, motion magnitude should be larger than standard, and repetition count for key terms should be greater than one.

Server generates the prompt sentence as a natural language string that includes at least (1) the original text to be translated into sign language, (2) information about the speaker emotional state, (3) information about the viewer emotional state, and (4) explicit instructions for controlling sign language parameters. Server forms the prompt sentence as follows in one example:

Please translate the following sentence into Japanese Sign Language.

Sentence: “Take this medicine three times a day after meals.”

The speaker's emotion is neutral.

The viewer may be confused about the content.

To make the explanation easy to understand, perform the sign expression slowly.

Emphasize important words such as “a day”, “three times”), “after meals”, and “take” by making the movements larger
and repeating them twice.

Use Japanese Sign Language expressions that are easy for beginners to understand.

In another example, server generates a prompt sentence for an utterance in a meeting scenario:

Please translate the following sentence into Japanese Sign Language.

Sentence: “Oh, do I really have to finish everything by today?”

The speaker's emotion is surprise.

The viewer is feeling anxious.

Show surprise, but use a tone that calms the viewer.

Keep the facial expression slightly surprised, but do not make the hand movements too intense.

Convey the content with clear and slow sign expressions.

By explicitly encoding both emotional states and detailed control instructions in the prompt sentence, server allows the generative AI model to produce sign language expression data that are systematically controllable and aligned with system-level policies. This differs from human-only processes or basic automation because server creates a machine-interpretable control space that coordinates recognition, emotion estimation, and motion synthesis in a unified computational structure.

Server transmits the prompt sentence to a generative AI model using an application programming interface of a generative model service. In one embodiment, server uses a large-scale language model that has been pre-trained on text data and instruction-following tasks, and optionally fine-tuned for sign language description. The generative AI model implements a neural network architecture, such as a transformer-based decoder with self-attention layers, layer normalization, and position-wise feed-forward layers. The generative AI model receives the prompt sentence as a sequence of token identifiers, embeds them into continuous vectors, processes them through multiple transformer layers, and outputs probability distributions over possible next tokens. The generative AI model samples or greedily selects tokens to form an output sequence.

Server receives sign language expression data from the generative AI model. In one variant, the generative AI model outputs a sequence of sign units represented by glosses and associated annotations describing orientation, movement direction, repetition, and facial expression cues. In another variant, the generative AI model outputs structured descriptions in natural language that indicate how each part of a sentence should be signed. Because server controls the content and structure of the prompt sentence, server can reliably parse the generative AI output and map it to an internal representation.

Server stores a motion information storage unit in a storage device. The motion information storage contains standard motion clips, each clip representing a canonical performance of a sign unit by a virtual person image. Each standard motion clip includes skeletal motion data, such as joint rotations over time, and may include associated facial motion data. Server associates each sign unit identifier with one or more standard motion clips.

Server interprets the sign language expression data and identifies corresponding standard motion clips from motion information storage. Server reads, from the sign language expression data, any instruction content or parameters relating to time length, motion amplitude, and repetition count for each sign unit. Server adjusts standard motion clips by altering playback speed to modify time length, scaling joint displacement values to modify motion amplitude, and repeating segments to achieve required repetition count. Server concatenates adjusted standard motion clips along a time axis, inserting transitional blending segments to avoid discontinuity in skeletal motion. Server likewise constructs facial motion data sequences based on expression instructions contained in the sign language expression data or derived from the combination of speaker and viewer emotional states.

Server encodes the resulting skeletal motion data and facial motion data into an animation data structure, such as a sequence of keyframes in a hierarchical skeleton format or a scene description format with animation extensions. Server transmits the animation data to terminal through a communication network.

Terminal receives sign language animation data from server and decodes the skeletal motion data and facial motion data. Terminal uses a three-dimensional rendering engine, such as a general-purpose graphics engine, to load a virtual person image model whose skeleton corresponds to the joint hierarchy in the motion data. Terminal applies joint rotations per frame to the virtual skeleton and applies facial motion parameters to the head and facial controls. Terminal executes a rendering pipeline on a graphics processing unit, including transformation, lighting, shading, and rasterization, to display the animated virtual person image on the display device.

User observes sign language animation displayed by terminal. User can interact with a user interface to adjust playback speed, pause or resume the animation, or request repetition of certain segments. Terminal captures these control inputs, modifies the playback timeline of the animation data, and updates the displayed frames accordingly. Terminal may further collect feedback information from user, such as whether the animation was easy or difficult to understand, and send this information to server for use in updating models and control rules.

By designing server and terminal to process specific data structures and execute specialized algorithms at each stage, the system achieves multiple technical effects. Because server performs noise reduction and feature extraction optimized for speech recognition and emotion analysis, the system reduces misrecognition and misclassification errors, which directly improves the fidelity of generated sign language. Because server uses a multimodal neural architecture for viewer emotion estimation, the system achieves greater robustness to noisy or missing individual modalities. Because server constructs a prompt sentence with explicit control parameters, the interaction between the control logic and the generative AI model becomes deterministic and repeatable, reducing variability of outputs and enabling fine-grained control without manual re-authoring of animations.

Because server employs parameterized standard motion clips in motion information storage, the system significantly reduces storage requirements compared to storing separate clips for each combination of speed, amplitude, and repetition count. Additionally, server can adjust motion parameters in real time based on updated viewer emotional states without regenerating motion from scratch or loading additional large motion files. This improves processing speed, reduces memory input/output, and lowers communication bandwidth usage between server and terminal.

Furthermore, the system improves computer technology itself by providing a new architecture in which recognition, emotion estimation, generative modeling, and motion synthesis are tightly coupled through explicit, machine-readable control instructions. This architecture allows the generative AI model to be guided according to non-human-intuitive parameters such as per-word emphasis counts and normalized amplitude scalars, which are difficult for humans to manage manually at scale. The system does not merely automate a human interpreter's work; instead, it uses high-dimensional feature vectors, deep neural network embeddings, and standardized motion parameterization to perform computations that are infeasible or impractical for human operators, and optimizes internal resource allocation in servers and terminals.

Alternative embodiments are also contemplated. Server can distribute some or all of the recognition or emotion estimation processing to terminal, so that terminal executes a reduced or full-featured speech recognition model and only sends recognized text and compressed feature representations to server, thereby reducing network load. Server can also vary neural network architectures, for example by using transformer encoders for speech features or graph neural networks for motion parametrization. Terminal can use either a native rendering engine or a browser-based rendering library to display sign language animation.

These and other variations remain within the technical framework of the claims, as long as server, terminal, and user cooperate as described to generate, control, and present sign language animation based on character information, speaker emotional state, viewer emotional state, and sign language expression data produced in response to a prompt sentence input to a generative AI model.

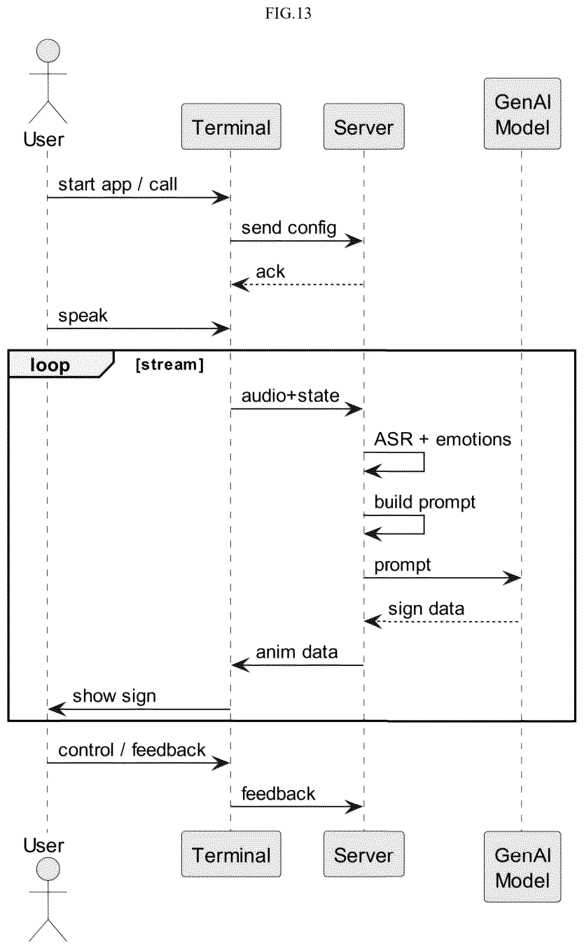

The following describes the processing flow using FIG. 13.

### Step 1:

User activates sign-language assistance and provides initial settings.

User uses the terminal to launch an application and to enable a sign-language assistance mode on a settings screen. User inputs or confirms a user identifier, selects avatar appearance, and selects preferences such as default sign speed and display style.

Terminal receives these values as input (user ID, avatar settings, sign style parameters), stores them in local storage, and constructs a structured configuration object. Terminal performs data formatting operations to convert the user selections into standardized identifiers and parameter values, and outputs a configuration message that is ready to be sent to the server.

### Step 2:

Terminal registers or updates the user profile on the server.

Terminal uses the communication interface to send the configuration message to the server over a secure protocol. The configuration message serves as input to the server.

Server receives the configuration message, parses user ID, device ID, avatar parameters, and sign style parameters, and queries a database to check for an existing profile. Server executes database operations to insert a new profile record or update an existing record accordingly, and outputs stored profile data associated with the user ID for later reference.

### Step 3:

User starts a voice-based session such as a meeting or call.

User operates the terminal to join an online meeting, start a call, or begin audio capture.

Terminal receives this operation as input, and in response initializes an audio capture module. Terminal configures the acoustic sensor by setting sampling rate, channel configuration, and buffer sizes, and outputs a continuous stream of raw audio samples representing the incoming sound.

### Step 4:

Terminal performs noise reduction and audio framing.

Terminal takes the raw audio samples as input, segments them into fixed-size frames (for example, 20 ms per frame), and passes each frame to a noise suppression algorithm.

Terminal applies spectral analysis, noise estimation, and spectral gain operations to reduce background noise, thereby generating noise-reduced audio frames.

Terminal groups sequences of noise-reduced frames into audio chunks corresponding to fixed durations (for example, 1 second per chunk), and outputs a sequence of noise-reduced audio chunks ready for compression.

### Step 5:

Terminal compresses audio and prepares transmission units.

Terminal uses an audio codec to encode each noise-reduced audio chunk from uncompressed pulse-code representations into a compressed format. The compressed data and chunk timestamps serve as output of this step.

Terminal packages compressed audio bytes together with chunk identifiers into transmission units, performs buffer management to queue units for network transmission, and outputs a stream of encoded audio transmission units.

### Step 6:

Terminal acquires and preprocesses face image information.

Terminal activates the image acquisition device and periodically captures frames of the region in front of the terminal. These raw image frames serve as input.

Terminal applies a face detection algorithm to each frame, locates the facial region, crops the frame to that region, and resizes the crop to a reduced resolution. Terminal then encodes the resized crop into a compressed image format. Terminal outputs compressed face image information associated with timestamps that correspond to capture times.

### Step 7:

Terminal collects user interface operation history.

Terminal uses callbacks of the user interface framework to receive raw interaction events as input, including tap events, scroll events, and swipe events with timestamps and coordinates.

Terminal records these events in an internal log and periodically aggregates them over a defined time window. Terminal computes statistical measures such as the number of taps, total scroll distance, and presence of rapid swipes. As a data processing operation, terminal transforms a sequence of discrete events into a compact interaction statistics vector and outputs this interaction statistics vector.

### Step 8:

Terminal collects biological information and prepares physiological statistics.

Terminal receives raw biological measurements as input from an external sensing device via a short-range wireless link or from an operating-system health data interface. The raw measurements include data such as instantaneous heart rate samples and, optionally, other vital signs.

Terminal filters noise in these measurements, computes averages, standard deviations, and variability indices over a time window, and normalizes the values into a physiological statistics vector. Terminal outputs biological statistics data aligned in time with interaction statistics and audio and image data.

### Step 9:

Terminal constructs user state information packets and transmits them.

Terminal collects, as input, the encoded audio transmission units, the compressed face image information, the interaction statistics vector, and the biological statistics vector.

Terminal combines these elements into a structured user state information packet, assigning fields such as “audio_data”, “face_image”, “interaction_stats”, and “bio_stats”, and attaches a session identifier and timestamp. Terminal performs serialization operations to encode the packet into a transferable format and outputs serialized user state information. Terminal then uses the communication interface to transmit the serialized user state information to the server over a communication network.

### Step 10:

Server receives user state information and reconstructs audio waveforms.

Server accepts serialized user state information from the communication network as input. Server parses the packet, extracts compressed audio data, and decodes the compressed audio into digital sound information in the form of raw sample sequences.

Server normalizes sampling frequency and amplitude by resampling and adjusting gain to a target loudness range, then outputs normalized digital sound information in a format suitable for feature extraction and recognition.

### Step 11:

Server performs acoustic feature extraction and speech recognition.

Server takes normalized digital sound information as input and segments it into overlapping frames. Server computes acoustic features such as mel-frequency filter bank coefficients or cepstral coefficients using signal-processing operations, and outputs sequences of acoustic feature vectors.

Server inputs the acoustic feature vectors into a trained speech recognition model implemented as a deep neural network with, for example, convolutional, recurrent, or attention layers. Server performs matrix multiplications and non-linear activations layer by layer, runs a decoding algorithm such as beam search with a language model, and maps acoustic features to symbol sequences. The output of this step is character information representing recognized text of the spoken utterances.

### Step 12:

Server computes prosodic and other sound feature information for speaker emotion identification.

Server uses the same or related digital sound information as input, and applies algorithms to calculate prosodic measures such as pitch contour, energy contour, speaking rate, and pause statistics. Server aggregates these into sound feature information vectors at frame-level or utterance-level.

Server passes the sound feature information to a trained emotion classification network, evaluates activations and softmax outputs to derive probabilities for different emotional categories, and selects the category with the highest probability as the speaker emotional state. Server outputs a discrete label or a numerical vector representing this speaker emotional state.

### Step 13:

Server performs multimodal viewer emotion identification using user state information.

Server takes as input the compressed face image, the interaction statistics vector, and the biological statistics vector from the user state information. Server decodes the compressed face image and uses a facial landmark detection algorithm to compute geometric positions of eyes, eyebrows, and mouth. Server converts these positions into a facial expression feature vector.

Server concatenates the facial expression feature vector, the interaction statistics vector, and the biological statistics vector to form a multimodal feature vector. Server inputs this multimodal feature vector into a trained multimodal emotion recognition model, executes neural network computations, and evaluates class probabilities. Server selects a class, such as “confused” or “interested”, with the highest probability as the viewer emotional state. Server outputs this viewer emotional state as a label or as a probability distribution over emotional categories.

### Step 14:

Server determines motion control parameters and constructs a prompt sentence.

Server receives character information, speaker emotional state, and viewer emotional state as input. Server analyzes the character information to detect key terms using natural-language processing operations such as part-of-speech tagging or importance scoring.

Server consults a control rule set or a learned mapping that links combinations of speaker emotional states and viewer emotional states to sign motion parameters such as speed, motion amplitude, repetition count, and facial expression intensity. Server thus generates instruction content describing how the sign language should be performed. Server then constructs a prompt sentence string that includes the original text, the speaker emotional state, the viewer emotional state, and the instruction content.

Server outputs the following prompt sentence in one example: Please translate the following sentence into Japanese Sign Language.

Sentence: “Take this medicine three times a day after meals.” The speaker's emotion is neutral.

The viewer may be confused about the content.

To make the explanation easy to understand, perform the sign expression slowly.

Emphasize important words such as “a day”, “three times”,
“after meals”, and “take” by making the movements larger
and repeating them twice.

Use Japanese Sign Language expressions that are easy for beginners to understand.

### Step 15:

Server provides the prompt sentence to a generative AI model and receives sign language expression data.

Server uses the prompt sentence as input to a generative AI model via an application programming interface. Server tokenizes the prompt sentence, passes the token sequence through the interface, and requests generation.

The generative AI model internally executes a neural network, such as a transformer-based decoder, using parameters that define attention weights and transformation matrices. The generative AI model outputs a sequence of tokens representing sign language expression data, such as a sequence of sign units with annotations. Server decodes these tokens back into text or a structured representation and outputs sign language expression data describing which sign units to use and how each should be performed.

### Step 16:

Server maps sign language expression data to standard motion clips with parameter adjustments.

Server takes the sign language expression data as input and parses it to obtain a sequence of sign units and associated performance parameters such as speed, amplitude, and repetition.

Server accesses motion information storage to retrieve standard motion clips corresponding to each sign unit. Server adjusts the time scaling of each clip to control speed, scales positional offsets or rotation angles to adjust motion amplitude, and duplicates motion segments to implement repetition count. Server aligns adjusted motion clips along a time axis, blends boundaries between clips to avoid discontinuities, and outputs continuous skeletal motion data and corresponding facial motion data.

### Step 17:

Server encodes sign language animation and transmits it to the terminal.

Server receives the skeletal motion data and facial motion data as input to an encoding module. Server converts these data into an animation file or embedded data structure, including frame timing, joint transformations, and facial parameter curves.

Server packages the animation data with metadata such as duration, frame rate, and segment identifiers, and transmits this package through the communication network to terminal. The output of this step is a delivered sign language animation data stream received by terminal.

### Step 18:

Terminal renders sign language animation and presents it to the user.

Terminal takes the sign language animation data as input and decodes the skeletal motion and facial motion parameters. Terminal loads a virtual person image with a compatible skeleton from local storage or memory.

Terminal applies skeletal motion data frame by frame to the skeleton, applies facial motion data to facial controls, and uses a three-dimensional rendering engine and graphics processor to compute visual frames. Terminal outputs rendered frames to the display device as a continuous sign language animation visible to user.

### Step 19:

User observes the animation and interacts with playback controls.

User views the sign language animation on the display and, as needed, uses the user interface to input commands such as “pause”, “rewind”, or “slow down”.

Terminal accepts these commands as input, modifies the playback state by adjusting current frame index or playback speed, and outputs updated animation frames reflecting the new playback state. Terminal may also capture simple feedback inputs from user, such as “understood” or “confused”, and transmit them to server for later model adjustment.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Human-computer interfaces that convert spoken language into sign language or gesture animations have conventionally relied on fixed dictionaries and one-way mappings from recognized text to sign expressions. In such conventional architectures, a processing apparatus typically performs automatic speech recognition on input audio and then performs a rule-based or template-based conversion of the resulting text into a sign sequence. These systems generally ignore prosodic features of the speech signal and emotional states of the speaker, and they present the same sign or gesture expression regardless of the emotional state or comprehension level of the recipient. As a result, conventional systems fail to capture nuances such as reassurance, urgency, or empathy in the speaker's voice, and they cannot adapt the content and style of the sign or gesture presentation to the emotional state of an elderly user or other vulnerable user.

From a computer-technology perspective, existing sign-translation systems are also architected as static pipelines in which each module (speech recognition, sign conversion, animation) operates independently with fixed parameters. These pipelines do not use dynamic prompt sentences or adaptive generative models; instead, they perform deterministic lookups in a sign dictionary. Consequently, the systems cannot flexibly adjust output text length, politeness level, pacing of gestures, or facial expression intensity based on real-time sensor input such as facial imagery or biometric signals. This leads to inefficient use of computational resources, because the same processing path is used irrespective of context, and to suboptimal user interaction, because the animation timing and expression styles are not tuned to user state.

Moreover, conventional systems do not perform multimodal emotion estimation that combines facial image analysis with biometric time-series analysis, nor do they utilize such multimodal emotion information as first-class input to a generative AI model via a context-rich prompt sentence. Instead, they treat user emotion, if considered at all, as a coarse external parameter. This prevents the computing system from performing fine-grained, per-user adaptation based on baseline physiology and expression patterns and from closing the loop between sensed emotional state and generated animation. As a result, the digital communication channel remains rigid and insensitive to emotional feedback.

There is therefore a need for a computer-implemented system that improves the technical functioning of a sign-language and gesture presentation pipeline by (i) jointly analyzing speech and multimodal user-state signals, (ii) dynamically constructing a prompt sentence for a generative AI model that encodes speaker emotion, user emotion, and output conditions, and (iii) generating and rendering sign or gesture animations whose motion parameters and facial expressions are automatically adjusted to the emotional state of an elderly user. Such a system should improve the adaptability, responsiveness, and efficiency of the underlying computing processes, thereby enhancing machine-mediated communication in caregiving and similar environments.

The specific processing by the specific processing unit 290 of the data processing device 12 in Application Example 2 is realized by the following means.

The present invention provides a server comprising a processor configured to execute instructions to acquire audio data representing speech of a caregiver from an audio input unit, to analyze the audio data using an acoustic model and a language model to generate utterance text data, to extract prosodic features from the audio data and estimate a speaker emotional state by applying a first emotion identification process, to acquire face image data and biometric information data of an elderly user from a user state acquisition unit, to estimate an elderly user emotional state from the face image data and the biometric information data by applying a second emotion identification process using an image analysis model and a time-series analysis model, to construct a prompt sentence for a generative AI model based on the utterance text data, the speaker emotional state, and the elderly user emotional state, to input the prompt sentence to the generative AI model and obtain sign expression data including at least sign gloss information and motion parameter information, to generate motion data of a virtual character based on the sign expression data, and to control a display device to render an animation of sign or gesture by dynamically adjusting at least a motion speed and a facial parameter in accordance with the elderly user emotional state. This enables the computing system to integrate multimodal emotion estimation into the content-generation pipeline, to dynamically parameterize a generative AI model via a context-rich prompt sentence, and to automatically adapt low-level animation parameters to the emotional state of the elderly user, thereby improving the technical operation of speech-to-sign conversion, increasing the responsiveness and personalization of the rendered animation, and enhancing the efficiency and effectiveness of computer-implemented communication support.

The term “audio input unit” refers to any hardware and software combination configured to capture an analog acoustic signal representing speech and convert the analog acoustic signal into digital audio data for processing by a processor.

The term “utterance text data” refers to digital text information generated by a speech recognition process that represents linguistic content of input audio data corresponding to a speaker's utterance.

The term “acoustic model” refers to a computational model, typically implemented as a statistical model or a neural network model, configured to map acoustic features extracted from audio signals to phonetic or subword units.

The term “language model” refers to a computational model, typically implemented as a probabilistic model or a neural network model, configured to assign probabilities to sequences of tokens and to assist in decoding recognized tokens into coherent text.

The term “prosodic features” refers to quantitative characteristics of an audio signal related to the manner of speaking, including but not limited to fundamental frequency, energy, duration, speech rate, and pause length.

The term “first emotion identification process” refers to processing that extracts prosodic features from audio data and applies a machine learning algorithm to estimate an emotional state of a speaker.

The term “user state acquisition unit” refers to any hardware and software combination configured to obtain sensor data related to a user, including at least face image data acquired by an imaging device and biometric information data acquired by a biological sensor or an external device.

The term “face image data” refers to digital image information including at least a region corresponding to a user's face that is suitable for analysis of facial expressions.

The term “biometric information data” refers to digital information representing physiological or physical measurements of a user, including but not limited to heart rate, body movement, or other body-related signals.

The term “second emotion identification process” refers to processing that estimates an emotional state of a user by applying at least an image analysis model to face image data and a time-series analysis model to biometric information data.

The term “image analysis model” refers to a computational model, typically implemented as a neural network or other pattern recognition model, configured to analyze image data to extract features or classify visual patterns such as facial expressions.

The term “time-series analysis model” refers to a computational model configured to analyze sequential data over time, such as biometric signals, in order to extract temporal features or classify temporal patterns.

The term “speaker emotion information” refers to data indicating an estimated emotional state of a speaker derived from analysis of audio data, including at least an emotion label and optionally an associated confidence value.

The term “elderly user emotion information” refers to data indicating an estimated emotional state of an elderly user derived from analysis of face image data and biometric information data, including at least an emotion label and optionally an associated confidence value.

The term “prompt sentence” refers to text information constructed for input to a generative AI model, the text information describing at least an utterance, emotional context, and conditions for generation of output data.

The term “generative AI model” refers to a machine-learning model, typically implemented as a large-scale neural network trained on data, configured to generate output data such as natural language text, structured representations, or motion instructions in response to an input prompt sentence.

The term “sign expression data” refers to data representing a sign-language or gesture expression, including at least information about sign units such as gloss identifiers and associated motion parameters.

The term “intermediate representation data” refers to data representing a sign-language or gesture expression in an abstract form that is not yet bound to a specific avatar skeleton but is suitable for conversion into concrete motion data.

The term “sign gloss information” refers to symbolic identifiers or tokens representing elementary sign units or sign words in a sign-language notation.

The term “motion parameter information” refers to data specifying characteristics of movement for a sign or gesture, including at least hand shape, position, trajectory, duration, and facial expression tags.

The term “virtual character” refers to a computer-generated graphical object having a skeletal or equivalent structure that can be animated to visually perform hand, arm, body, and facial movements.

The term “motion data of a virtual character” refers to data defining time-varying poses or transformations of elements of a virtual character, including joint rotations, positions, and facial deformation parameters.

The term “display device” refers to any apparatus capable of visually presenting images or animations, including but not limited to a flat-panel display, a head-mounted display, or a projection surface.

The term “motion speed” refers to a temporal characteristic of an animation, including at least the rate or duration at which movements within the animation are executed.

The term “facial parameter” refers to a control value used to define a facial expression of a virtual character, including but not limited to parameters for eye, mouth, eyebrow, and cheek configurations.

The term “storage that records baseline facial features and baseline biometric features” refers to a memory device or data repository that stores reference values or distributions of facial expression features and biometric features for a user under typical or normal conditions.

The term “gesture expression style” refers to qualitative and quantitative aspects of a gesture or sign presentation, including at least the size of movements, smoothness, emphasis, and expressiveness of accompanying facial expressions.

The term “joint transformation data” refers to data specifying transformations, such as rotations and translations, applied to joints or bones of a virtual character's skeletal structure over time.

The term “skeletal structure of the virtual character” refers to a hierarchical arrangement of joints or bones used to control deformation and movement of a virtual character's graphical mesh.

The term “interpolation algorithm” refers to a computational method for generating intermediate values between known data points, used in animation to compute intermediate frames between key poses.

The term “sign units” refers to discrete elements or segments of a sign-language expression, each corresponding to a gloss or a basic sign component.

In one embodiment, a server, a terminal, and a user cooperate to implement a system that converts spoken instructions of a caregiver into sign-language or gesture animations that are dynamically adapted to emotional states of both the caregiver and an elderly user. The server and the terminal are realized as general-purpose information processing devices executing dedicated programs stored in non-transitory storage media. The user is an elderly care recipient who observes a virtual character displayed on the terminal.

### A. Hardware and Software Configuration

The server includes at least one central processing unit (CPU), at least one graphics processing unit (GPU), a main memory, a non-volatile storage device, and a network interface. The server executes a general-purpose operating system, such as a server-class operating system, and runs an application framework, such as a script-language web framework, and a machine-learning framework such as a deep-learning library implementing tensor operations and automatic differentiation.

The terminal includes a CPU, a graphics processing unit integrated into a system-on-chip or provided separately, a display device, a microphone, a camera, a wireless communication module, and a local storage device. The terminal executes a mobile operating system and runs a dedicated application that incorporates a 3D runtime environment, such as a game engine runtime capable of rendering skeletal animations in real time.

The server and the terminal communicate over a network using a secure communication protocol such as a transport-layer security-based protocol. The user is situated in front of the terminal so that the camera can capture the user's face and the display device can present a virtual character performing sign or gesture animations.

### B. Server-Side Functional Modules

The server implements multiple software modules, each executed by the processor.

### 1. Speech Recognition Module

The server includes a speech recognition module that receives digital audio data from the terminal. The speech recognition module uses an acoustic model and a language model implemented within a deep-learning framework. In one embodiment, the acoustic model is a neural network comprising a stack of convolutional layers followed by bidirectional recurrent layers or transformer encoder layers, configured to map sequences of acoustic feature vectors (such as log-Mel spectrogram frames) to distributions over phonetic units or subword tokens. The language model is a neural network comprising multiple transformer decoder layers configured to assign probabilities to token sequences.

The server computes acoustic features by applying a signal-processing library that performs Fourier transforms and Mel-filterbank operations. The server then feeds the resulting feature sequence into the acoustic model and obtains posterior probabilities over tokens at each time step. The server performs beam-search decoding that combines the acoustic log-likelihoods and language-model log-likelihoods to produce utterance text data.

This architecture improves recognition accuracy for caregiver speech, especially in noisy care environments, by leveraging joint optimization of acoustic and language models.

### 2. First Emotion Identification Module

The server includes a first emotion identification module that performs a first emotion identification process for the caregiver. The server uses a signal-processing library to compute prosodic features, including fundamental frequency trajectories, frame energy, speech rate (estimated from syllable-like energy peaks), and pause duration statistics. The server constructs a feature sequence and feeds the sequence into a neural-network classifier, such as a bidirectional long short-term memory network or a transformer-based sequence classifier.

The classifier outputs a probability distribution over discrete emotion labels, such as calm, reassuring, warning, joyful, or angry. The server then retrieves baseline statistics for the caregiver from storage, where the server has previously accumulated typical values of pitch, energy, and speaking rate. The server compares the current feature statistics with the baseline statistics and adjusts the predicted label if necessary. For example, if the classifier predicts neutral but the current pitch and energy are significantly lower than baseline, the server adjusts the label to calm. This adjustment reduces misclassification due to individual speaking habits and increases robustness of emotion estimation.

### 3. User State Acquisition and Second Emotion Identification Modules

The server cooperates with a user state acquisition unit implemented on the terminal, which provides face image data and biometric information data. The server includes a second emotion identification module that implements a multimodal analysis pipeline.

The server uses an image-processing library to decode and normalize face image data received from the terminal. The server resizes images to a fixed resolution, normalizes pixel values, and applies data augmentation, such as random cropping and horizontal shifting, during training to improve model robustness. The server feeds normalized images into an image analysis model, such as a convolutional neural network or a vision transformer network, which outputs feature vectors representing facial expression characteristics. A classification head maps these feature vectors to probabilities over emotion classes, such as neutral, anxious, confused, joyful, and distressed.

The server also receives biometric information data, such as heart rate sequences and body-movement indices. The server processes these time-series data using a time-series analysis model, such as a gated recurrent unit or a one-dimensional convolutional network, which outputs a stress or arousal score and related temporal features. The server concatenates facial-expression features and biometric features into a multimodal feature vector and applies a fully connected neural network that outputs an elderly user emotion information value, including an emotion label and a confidence value.

During training of these models, the server minimizes a loss function such as cross-entropy between predicted emotion labels and ground-truth labels, and the server updates network weights by gradient-descent-based optimization, such as Adam. The server applies regularization techniques, such as dropout and weight decay, and optionally uses data balancing or focal loss to mitigate label imbalance. These specific configurations enable the server to perform accurate real-time emotion estimation in noisy and variable physiological conditions.

The server further accesses storage that records baseline facial features and biometric features for each user. By comparing current features against baseline distributions, the server adjusts emotion decisions for users who naturally have elevated heart rates or characteristic facial expressions. This personalized correction reduces false alarms and improves overall classification accuracy.

### 4. Prompt Generation Module for a Generative AI Model

The server includes a prompt generation module that constructs a prompt sentence for input to a generative AI model. The prompt generation module receives the utterance text data, the speaker emotion information, and the elderly user emotion information. The server stores prompt templates in a configuration store, where each template has placeholders for the utterance text and emotion labels and can specify conditions such as desired politeness level, length of explanation, presence of reassurance, and gesture expression style.

The server fills in the placeholders using string manipulation functions executed by the processor. When the elderly user emotion information indicates an anxious state, the server selects or constructs a template that instructs the generative AI model to add reassuring content and to simplify wording. When the elderly user emotion information indicates a calm state, the server can select a template that specifies concise explanations.

In one example, the server constructs the following prompt sentence as text:

“You are a generative AI model specialized in converting Japanese caregiver instructions into Japanese Sign Language (JSL) for elderly users.
1. Rephrase the following Japanese sentence into gentle, easy-to-understand Japanese for an elderly person.
2. The speaker's emotion is ‘calm and reassuring’, and the elderly user's emotion is ‘anxious’. Add one extra sentence to reduce the user's anxiety.
3. Convert the rephrased sentence into a JSL gloss sequence following JSL grammar.
4. For each gloss, output motion instructions including handshape, position, movement, duration, and facial expression tags such as CALM and SMILE.

### Speaker's Utterance:

“I'm going to take your blood pressure now. I'll wrap a belt around your arm a little, but it won't hurt.”

By encoding emotional context and output constraints directly into the prompt sentence, the server causes the generative AI model to produce sign expression data that is structurally consistent with sign-language grammar and adaptively tailored to the user's state. This is not a mere replacement of human translation, but a specific technical mechanism for guiding a generative model using multimodal sensor-derived parameters.

### 5. Generative AI Model Interface

The server maintains an interface to a generative AI model, which is a neural network architecture having multiple transformer layers with self-attention mechanisms. The generative AI model is pretrained on large language corpora and fine-tuned on sign-language gloss sequences and motion-description data. The model inputs tokenized prompt sentences and outputs sequences of tokens describing rephrased text, gloss sequences, and motion descriptions.

The server controls inference parameters, such as maximum output length, temperature, and top-k or top-p sampling thresholds, to balance creativity and determinism. The server parses the output into sign expression data comprising sign gloss information and motion parameter information. The use of a large-scale generative AI model allows the server to generate sign expressions that are contextually rich and varied while still satisfying strict constraints encoded in the prompt sentence, thereby improving expressiveness and clarity beyond what static rule-based systems can provide.

### C. Avatar Motion Generation and Rendering

### 1. Motion Data Generation

The server includes a motion generation module that converts sign expression data into motion data for a virtual character. The server stores a skeletal structure for the virtual character, defining joints such as wrists, elbows, shoulders, neck, head, jaw, and facial control points. The server maintains a mapping from symbolic parameters in the motion parameter information (such as handshape labels, position categories, movement types, and facial tags) to numerical joint transformations.

The server calculates key poses for each sign unit based on the associated handshape and position, using predetermined joint angles and positions relative to a body-centered coordinate system. The server synthesizes motion trajectories by interpolating between key poses according to the specified movement types and durations, for example using cubic spline interpolation for smooth hand paths. The server applies facial expression tags by adjusting blend-shape weights or joint rotations for eyebrows, eyelids, and mouth.

When the elderly user emotion information indicates anxiety, the server scales the duration parameters so that motions are slower, and increases the intensity of facial expressions associated with calmness or reassurance. This parameter scaling is performed by deterministic arithmetic operations on the motion parameter information before the server sends motion data to the terminal. Consequently, the resulting animation is technically adapted to the user's state.

### 2. Terminal-Side Rendering

The terminal receives motion data and rephrased text from the server. The terminal uses its 3D runtime engine to load the virtual character model and to bind motion data to the skeletal structure. The terminal calculates per-frame joint transformations by interpolating between keyframes defined in the motion data. The terminal uses its graphics processing unit and a graphics API to perform vertex skinning, lighting, shading, and texture mapping, rendering the animated virtual character on the display device.

The terminal overlays text captions based on the rephrased text from the sign expression data. The terminal can adjust scaling, contrast, and playback speed according to user preferences stored locally. By executing these graphics operations, the terminal converts the abstract output of the generative AI model into concrete physical signals on the display device, thereby controlling an actual machine.

### D. Technical Effects and Improvements

The described configuration yields multiple technical advantages that go beyond mere automation of human interpretation.

First, the server improves recognition and translation accuracy by tightly integrating acoustic modeling, language modeling, and emotion analysis. The first emotion identification process uses specific prosodic features and a trained classifier to provide speaker emotion information that conditions subsequent translation, reducing mistranslation of affective content such as reassurance or warning. This results in more precise mapping from raw audio signals to sign expressions.

Second, the server improves computational efficiency and bandwidth usage by decoupling heavy inference and rendering tasks between the server and the terminal. The server performs computationally intensive deep-learning inference on GPUs and sends compact motion data to the terminal instead of full video streams. This reduces network load and allows low-power mobile terminals to render high-quality animations without performing heavy neural-network computations locally.

Third, the server provides a specific dataflow and data structures—prosodic feature sequences, multimodal emotion feature vectors, prompt sentences, sign expression data, and joint transformation sequences—that enable modular yet interdependent processing. Each structure is designed to carry only essential information for the next module, which reduces redundancy and improves memory usage compared with passing raw sensor data between all modules.

Fourth, the multimodal emotion estimation and baseline-corrected classification improve robustness of the system against noise and user variability. The server combines facial expression features and biometric features within a multimodal neural network trained with a specific loss function and regularization scheme. This approach yields higher classification accuracy compared with using only facial images or only biometrics and allows dynamic adjustment of animation parameters based on reliable emotion information.

Fifth, the use of prompt sentences that encode both speaker emotion and user emotion, as well as explicit output constraints, causes the generative AI model to operate under a non-conventional constraint regime. The generative AI model is not merely generating free-form text but is generating sign expression data, including gloss sequences and motion parameters aligned with emotional context. This structured prompting results in sign expressions that are both linguistically appropriate and technically aligned with the avatar motion system. This is a specific improvement in computer-implemented generation of multimodal content.

### E. Alternative Embodiments

The server can substitute different neural architectures while maintaining the described functional relationships. For example, the acoustic model can be a conformer-based encoder; the emotion classifiers can be transformer encoders; the generative AI model can be any sequence-to-sequence or decoder-only transformer network. The loss functions can include auxiliary terms that penalize inconsistent gloss sequences or unrealistic motion parameters, improving motion realism.

The terminal can be any computing device with a display and sufficient graphics capability, including handheld devices, head-mounted displays, or wall-mounted displays. The user state acquisition unit can additionally use other sensors such as depth cameras or thermal cameras to supplement emotion estimation.

The server can store domain-specific sign dictionaries and constraint rules that post-process the generative AI output, mapping non-canonical glosses to standardized ones. This post-processing can include rule-based corrections or neural reranking, further enhancing technical reliability of the output.

By implementing the above modules and dataflows, the server and the terminal together realize a concrete computing system that uses a generative AI model and a prompt sentence not only for higher-level language tasks but also for precise control of a virtual character's motion and expression in response to multimodal emotion signals. This structure yields improvements in accuracy, responsiveness, and efficiency in computer-implemented speech-to-sign conversion and achieves technical effects that are distinct from human translation or generic business workflows.

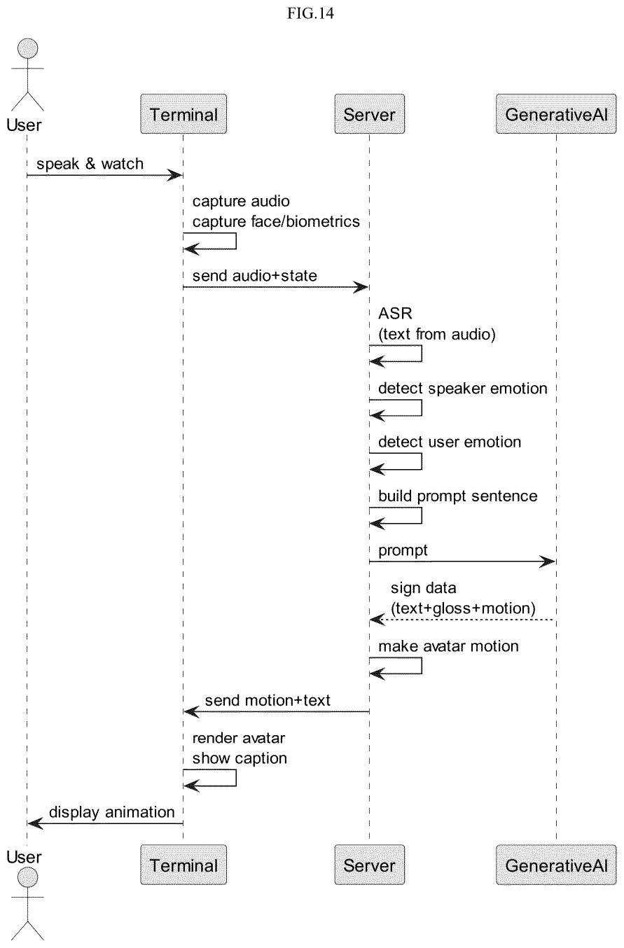

The following describes the processing flow using FIG. 14.

### Step 1:

Terminal initializes sensing and communication environment.

Terminal initializes an audio capture session using a mobile operating system audio API and configures the sampling rate and bit depth (for example, 16 kHz, 16-bit). Terminal initializes a camera session using a camera framework and configures frame resolution (for example, 640×480) and frame rate. Terminal establishes a secure network connection to the server using a transport-layer security-based protocol and retrieves or confirms a session identifier.

Input: user profile information (for example, user ID, caregiver ID) and device capabilities.

Processing: Terminal reads stored configuration data from local storage (for example, sign size, animation speed preferences) and initializes internal buffers for audio frames, image frames, and biometric data. Terminal sets up callback handlers to receive sensor data and to send network packets.

Output: an initialized sensing and communication state in which the terminal is ready to capture audio, video, and biometric data and to exchange data with the server.

### Step 2:

Terminal captures caregiver audio and generates noise-reduced audio data.

Terminal starts audio recording when the caregiver begins speaking, as detected by a user interface command or by exceeding an amplitude threshold.

Input: analog microphone signal.

Processing: Terminal samples the analog signal into digital frames, groups the frames into windows, and applies a noise suppression library that performs spectral analysis and attenuation of estimated noise components. Terminal may perform short-time Fourier transforms to obtain magnitude spectra, estimate a noise spectrum during non-speech segments, and subtract this noise estimate from current frames. Terminal concatenates processed frames into an audio segment and detects silence at the end of the utterance using an energy-based threshold.

Output: a noise-reduced digital audio segment representing one caregiver utterance, stored in a buffer and formatted for transmission.

### Step 3:

Terminal captures user face images and biometric information.

Terminal activates the camera to capture frames of the user's face while the caregiver is speaking.

Input: raw image frames from the camera sensor; biometric measurements from a wearable device (for example, heart rate, acceleration).

Processing: Terminal uses a face detection library to compute bounding boxes for faces in each frame and selects the box with the largest area or the box closest to the previous frame position. Terminal crops the face region, resizes it to a model-specific size, and encodes it as a compressed image. Terminal reads biometric data from a short-range wireless interface and accumulates samples over a fixed time window. Terminal calculates statistical features such as mean heart rate, standard deviation, and average movement index.

Output: a cropped, compressed face image and a feature vector of biometric statistics associated with the same time window.

### Step 4:

Terminal packages sensor data and sends it to the server.

Terminal generates a structured payload including the noise-reduced audio, face image, and biometric features.

Input: noise-reduced audio segment, face image, biometric feature vector, and session metadata (for example, timestamps, IDs).

Processing: Terminal encodes metadata and biometric features into a structured text format (for example, JSON) and combines this with the binary audio and image data in a request message. Terminal signs or encrypts the payload as needed and sends the message to a designated server endpoint via a secure protocol. Terminal then waits for acknowledgment or a response from the server.

Output: a transmitted request containing synchronized audio and user state data available for processing on the server.

### Step 5:

Server receives and normalizes audio data for speech recognition.

Server accepts the incoming request from the terminal and extracts the audio, image, and biometric components.

Input: noise-reduced digital audio segment from the terminal.

Processing: Server converts the audio to a standard internal format (for example, single-channel, float32) and normalizes amplitude to a target root-mean-square value. Server applies a voice activity detector to remove any residual leading and trailing silence. Server then computes acoustic features, such as log-Mel spectrograms, by applying a windowed Fourier transform and Mel-filterbank integration.

Output: a sequence of acoustic feature vectors suitable for input to the speech recognition model.

### Step 6:

Server performs speech recognition and generates utterance text data.

Server uses a trained acoustic model and language model to convert the acoustic features into text.

Input: acoustic feature sequence from Step 5.

Processing: Server feeds the feature sequence into an acoustic model implemented as a neural network (for example, a stack of convolutional and transformer encoder layers) to obtain token-level probability distributions. Server performs beam search, combining acoustic probabilities with language-model probabilities from a neural language model, to determine the most likely token sequence. Server converts tokens to characters or words, and then consults a domain dictionary to normalize specific terms (for example, mapping recognized variants to standard medical terminology).

Output: utterance text data representing the caregiver's spoken instructions in a normalized textual form.

### Step 7:

Server extracts prosodic features and estimates the caregiver's emotion (first emotion identification process).

Server uses the same normalized audio data to estimate the speaker's emotional state. Input: normalized digital audio segment (or acoustic features) representing the caregiver's speech.

Processing: Server computes prosodic features such as pitch contours, energy per frame, speech rate estimates, and pause durations. Server constructs a prosodic feature sequence and inputs this sequence into a trained emotion classifier implemented as a neural network (for example, a bidirectional recurrent network or transformer). The classifier outputs class probabilities for emotion categories. Server retrieves baseline prosodic statistics for the caregiver from storage and calculates deviations between current and baseline values. Server adjusts the predicted emotion label when deviations exceed predetermined thresholds, thereby aligning the classification with individual speaking habits.

Output: speaker emotion information including a discrete emotion label (for example, calm, reassuring) and optionally a confidence value.

### Step 8:

Server processes face image data and biometric information to estimate the elderly user's emotion (second emotion identification process).

Server uses a multimodal analysis pipeline to infer the user's emotional state.

Input: cropped face image from the terminal and biometric feature vector from Step 3.

Processing: Server decodes and resizes the face image and normalizes pixel values. Server feeds the normalized image into an image analysis model (for example, a convolutional neural network) and obtains a facial feature vector and preliminary emotion probabilities. Server processes biometric features with a time-series analysis model (for example, a gated recurrent unit) to derive stress and arousal indicators. Server concatenates facial and biometric features into a single multimodal feature vector and applies a fully connected classifier that outputs emotion probabilities for user states such as anxious, calm, or confused. Server retrieves baseline facial and biometric profiles for the user from storage and compares current values to baseline to adjust the emotion label when, for example, heart rate is high relative to the user's normal range.

Output: elderly user emotion information including a discrete emotion label (for example, anxious) and a confidence value.

### Step 9:

Server constructs a prompt sentence for the generative AI model.

Server uses the utterance text data, speaker emotion information, and elderly user emotion information to generate a context-rich prompt.

Input: utterance text data from Step 6, speaker emotion information from Step 7, and elderly user emotion information from Step 8.

Processing: Server selects a prompt template from configuration storage based on the combination of speaker and user emotions. Server replaces placeholders in the template with the actual utterance text and emotion labels, and inserts explicit conditions such as “use gentle language,” “add one reassuring sentence,” and “output sign glosses and motion instructions.” Server constructs a complete text prompt that instructs the generative AI model on how to rephrase and convert the input.

Output: a prompt sentence ready for input to the generative AI model.

### Step 10:

Server calls the generative AI model and obtains sign expression data.

Server sends the prompt sentence to a generative AI model that produces text and motion descriptions.

Input: prompt sentence from Step 9.

Processing: Server tokenizes the prompt sentence and passes the tokens to a transformer-based generative AI model. The model performs multiple layers of self-attention and feed-forward computations to generate an output sequence of tokens. Server decodes the tokens into a rephrased text, a sequence of sign glosses, and structured motion descriptions, following a predetermined output format. The server may enforce additional constraints such as maximum length and allowable tags by filtering or truncating the output according to rules.

Output: sign expression data including at least rephrased text for the elderly user, sign gloss information for each sign unit, and motion parameter information describing handshape, position, movement, duration, and facial tags.

### Step 11:

Server refines sign expression data and generates motion data for a virtual character.

Server converts the abstract sign expression data into motion data compatible with the avatar skeleton used by the terminal.

Input: sign expression data from Step 10, and skeletal configuration data for the virtual character.

Processing: Server maps gloss-level motion parameters to specific joints of the avatar's skeletal structure using a mapping table. Server determines key poses by applying joint angles and positions prescribed by handshape and position parameters. Server generates motion trajectories between key poses using interpolation (for example, cubic splines), and assigns timing based on duration parameters. Server modifies durations and facial expression intensities when the elderly user emotion information indicates anxiety, for example by increasing durations and amplifying calm facial tags. Server compiles joint transformations and facial parameters into a frame-indexed motion data structure.

Output: motion data of the virtual character, including time-stamped joint transformations and associated facial parameters.

### Step 12:

Server encodes and transmits motion data and text to the terminal.

Server prepares a response message that the terminal can use to render the animation.

Input: motion data from Step 11 and rephrased text from Step 10.

Processing: Server serializes motion data into a compact representation (for example, binary encoding with delta compression of joint rotations and positions) and attaches the rephrased text and metadata (for example, estimated total duration, emotion tags). Server packs these elements into a response payload conforming to the server-terminal protocol and sends the payload to the terminal via a secure transport.

Output: a transmitted response containing avatar motion data and caption text for use by the terminal.

### Step 13:

Terminal decodes motion data and renders the virtual character animation with captions.

Terminal receives the server response and displays the adapted sign or gesture animation to the user.

Input: encoded motion data, rephrased text, and metadata from Step 12.

Processing: Terminal decodes the motion data into a sequence of joint transformations and facial parameters and loads them into the 3D runtime engine. Terminal applies these transformations to the avatar's skeletal structure for each frame, performing interpolation when necessary. Terminal uses its graphics processing unit to execute vertex skinning, lighting, and shading operations, rendering each frame to the display device. Terminal overlays the rephrased text at a designated position on the screen, synchronized with the animation timeline. Terminal may adjust playback speed or scale based on local user preferences.

Output: a rendered virtual character performing sign-language or gesture animation with synchronized captions, presented on the terminal display for the user.

### Step 14:

User observes the animation and system prepares for subsequent adaptive cycles.

User watches the virtual character and reads the captions, and the user's emotional state may change as a result of clearer and more reassuring communication.

Input: visual and textual output from the terminal display in Step 13 (from the user's perspective).

Processing: User's facial expressions and biometric signals naturally respond to the content (for example, heart rate decreases, facial tension reduces). Terminal continues to capture new face images and biometric measurements in subsequent interactions. Server receives these updated data and repeats emotion estimation and prompt generation, refining sign expressions and motion parameters over time based on feedback.

Output: updated user state signals that feed into future iterations of the processing pipeline, enabling continuous adaptation of generative AI model outputs and avatar behavior to the user's evolving emotional state.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

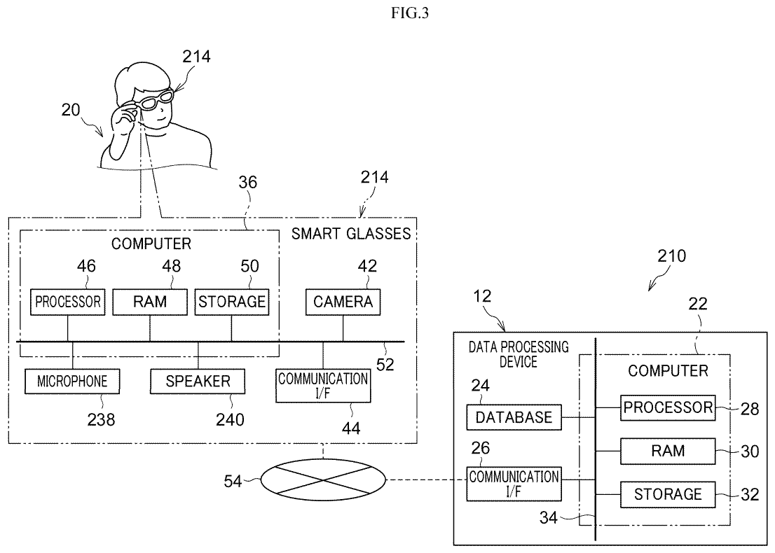

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

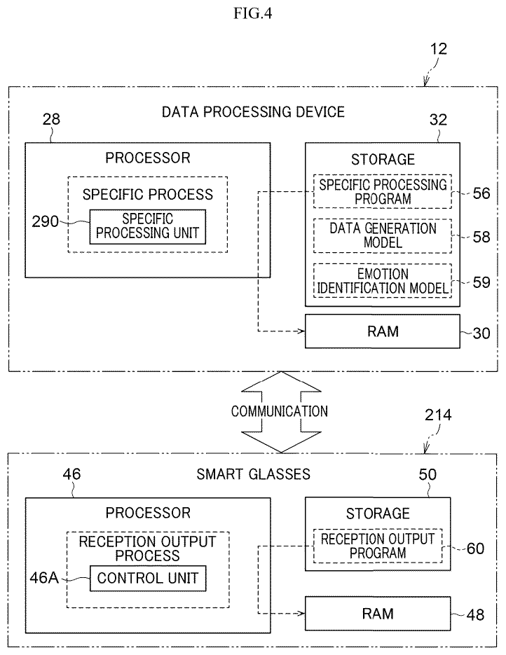

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

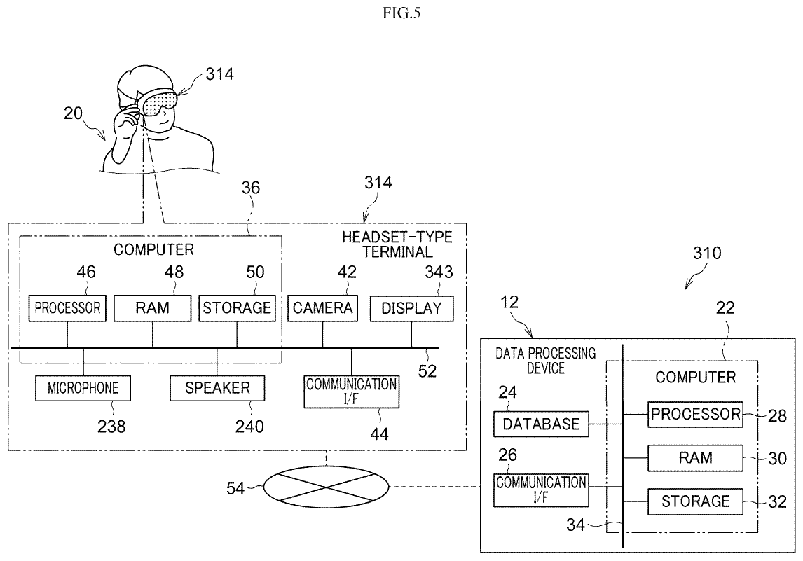

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

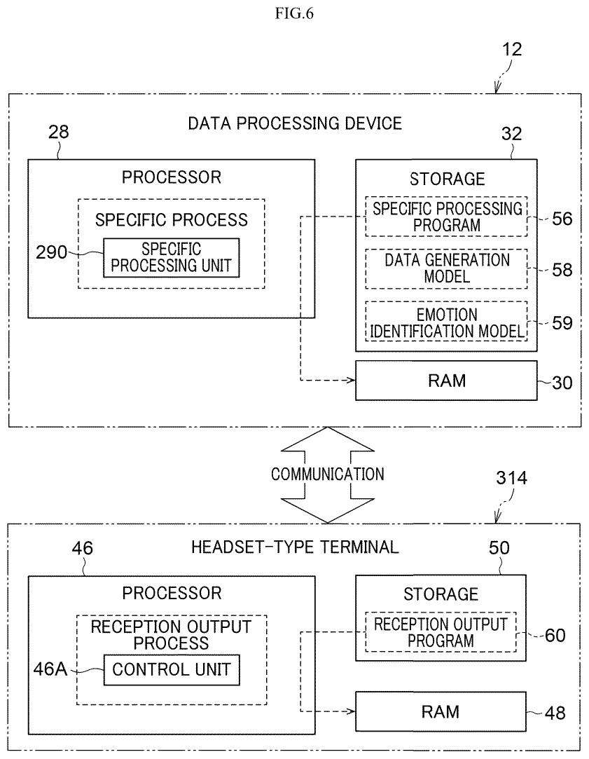

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

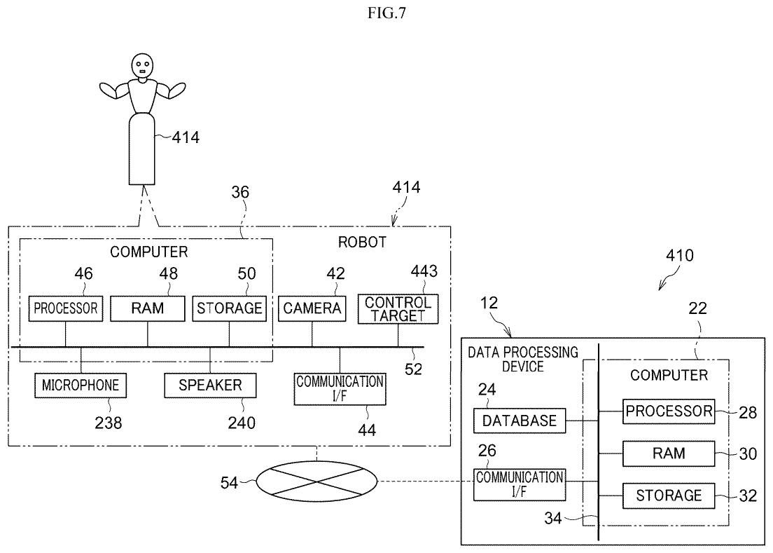

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

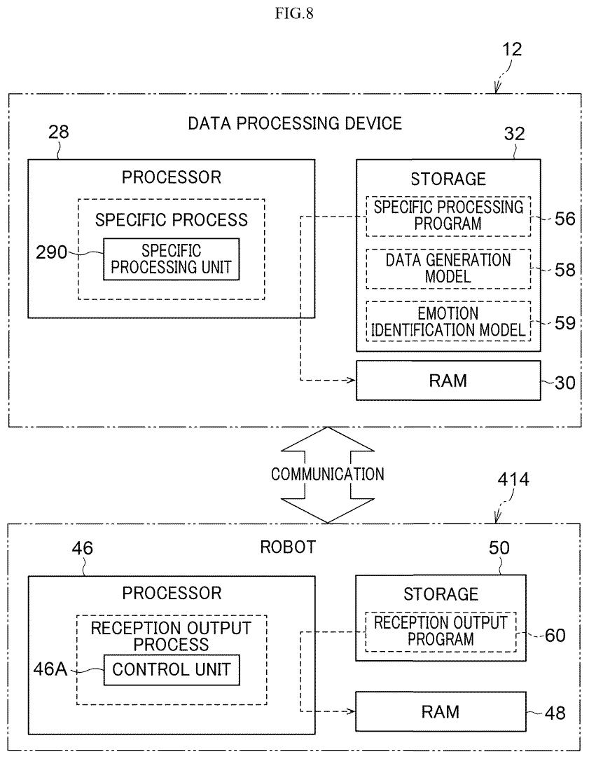

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

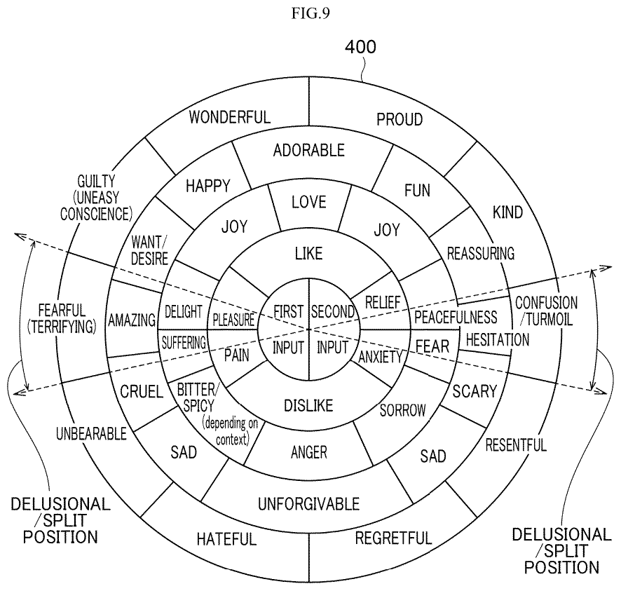

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

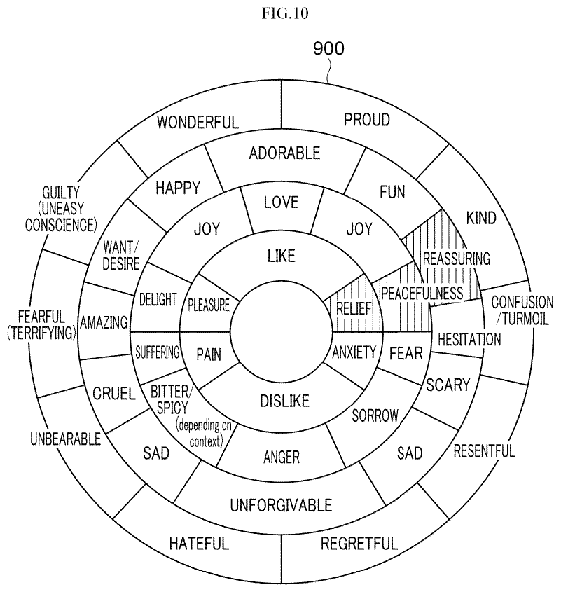

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure.

Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire audio information at an information processing terminal used by a user and transmit the audio information to an information processing apparatus via a communication network,
analyze the audio information at the information processing apparatus and convert the audio information into character information on the basis of an acoustic model and a language model,
extract prosodic feature quantities including fundamental frequency, sound pressure, speech rate, and pause duration from the audio information at the information processing apparatus and classify the prosodic feature quantities by a machine learning method to specify emotion information,
generate a sign language intermediate representation including a target sign language type and non-manual behavior on the basis of the character information and the emotion information at the information processing apparatus,
generate a prompt sentence including the sign language intermediate representation, the emotion information, and the target sign language type at the information processing apparatus and input the prompt sentence to a generative AI model to cause the generative AI model to generate sign language expression data,
convert the sign language expression data into an animation script including skeletal information, joint angle information, and facial expression information at the information processing apparatus, and
cause the information processing terminal to receive the animation script and display sign language motion by controlling a skeletal structure and facial expression parameters of a virtual person by three-dimensional image processing, and change an appearance and motion characteristics of the virtual person on the basis of user setting,
thereby providing the system.

### (Supplementary 2)

The system according to supplementary 1,
wherein the processor is configured to
divide the audio information into analysis sections of a predetermined time length, acquire audio feature quantities by feature extraction processing, determine a probabilistically optimal character string by search processing using the acoustic model and the language model, and correct recognition results of technical terms and specific expressions on the basis of field-specific dictionary data.

### (Supplementary 3)

The system according to supplementary 1,
wherein the processor is configured to
include, in the prompt sentence, the sign language type, context information, and an intensity index of non-manual behavior corresponding to the emotion information as generation instructions, obtain structured sign language expression data including hand shape, position, movement, duration, and facial expression tags from the generative AI model, and arrange a joint motion sequence and a facial expression change sequence of the virtual person on a time axis on the basis of the structured sign language expression data.

### Application Example 1

### (Supplementary 1)

A system comprising a processor,
wherein the processor is configured to
acquire audio information, and
generate character information based on the audio information, and
extract prosodic information from the audio information and identify emotion information, and
construct a generation input sentence based on the character information and the emotion information, and
input the generation input sentence to a generative information processing model to generate symbolic information including sign-language information and non-manual information, and
convert the symbolic information into motion information including skeletal information and facial-expression information, and
generate animation information that defines time-series postures of body parts and facial parts of a three-dimensional display target based on the motion information, and cause a visual expression to be displayed using the animation information.

### (Supplementary 2)

The system according to supplementary 1,
wherein the processor is configured to
generate the character information by mapping an audio signal to a corresponding character string using an acoustic model and a language model of a statistical type or a machine-learning type, and
analyze prosodic feature quantities including tone, fundamental frequency, duration, intensity, and pause of the audio information using a machine-learning algorithm to identify the emotion information, and
generate, as the generation input sentence, a prompt sentence described in a natural language that includes the character information, the emotion information, a target sign-language type, an output format, and motion-style instructions.

### (Supplementary 3)

The system according to supplementary 1,
wherein the processor is configured to
select motion patterns corresponding to sign-language units and non-manual elements from a pre-stored group of motion elements to convert the symbolic information into the motion information, and
connect and interpolate the motion patterns in a time direction such that speed, amplitude, and facial-expression intensity are continuous in accordance with the emotion information to generate the animation information, and
control a skeletal model and a facial model of a virtual person on a display device based on the animation information to convey content and emotion of the audio information to a user.

### Example 2

### (Supplementary 1)

A system comprising a processor,
wherein the processor is configured to
acquire sound information as an electrical signal from an acoustic sensor and convert the electrical signal into digital sound information,
perform acoustic analysis and linguistic analysis on the digital sound information to generate character information corresponding to the digital sound information,
extract sound feature information including prosodic features from the digital sound information and identify a speaker emotional state based on the sound feature information,
acquire user state information including at least part of face image information of a user, operation history information of a user interface, and biological information of the user, and identify a viewer emotional state of the user based on the user state information,
generate a prompt sentence to be input to a generative artificial intelligence model based on the character information, the speaker emotional state, and the viewer emotional state, input the prompt sentence to the generative artificial intelligence model, and obtain sign language expression data from the generative artificial intelligence model,
generate skeletal motion data and facial motion data of a virtual person image based on motion information and expression information corresponding to the sign language expression data, and output a sign language animation to a display device based on the skeletal motion data and the facial motion data,
control a terminal device including the acoustic sensor and a display apparatus, an information processing device including a sound recognition function, a speaker emotion identification function, a viewer emotion identification function, and a sign language generation function, and a user who operates the terminal device to view the sign language animation, so that the terminal device, the information processing device, and the user operate in cooperation with each other through a communication network.

### (Supplementary 2)

The system according to supplementary 1,
wherein the processor is configured to
extract important terms from the character information, determine instruction content specifying at least one of sign speed, motion magnitude, repetition count, and expression intensity in accordance with the speaker emotional state and the viewer emotional state, construct the prompt sentence including the instruction content together with the character information, the speaker emotional state, and the viewer emotional state, and provide the prompt sentence to a generative artificial intelligence model that has been trained on large-scale data to output a sequence of sign units or intermediate representation data as the sign language expression data.

### (Supplementary 3)

The system according to supplementary 1,
wherein the processor is configured to
refer to motion information storage in which standard motion clips are stored in association with respective sign units included in the sign language expression data, adjust at least one of time length, motion amplitude, and repetition count of the standard motion clips based on the instruction content included implicitly or explicitly in the sign language expression data, connect the adjusted standard motion clips on a time axis to generate continuous skeletal animation data and facial animation data, and cause a three-dimensional display function of the terminal device to reproduce a virtual person image performing sign language based on the continuous skeletal animation data and the facial animation data.

### Application Example 2

### (Supplementary 1)

A system comprising a processor,
wherein the processor is configured to
acquire, via an audio input unit, audio data representing speech of a caregiver as a speaker,
analyze the audio data using an acoustic model and a language model to generate utterance text data corresponding to the speech,
extract prosodic features from the audio data and estimate an emotional state of the speaker by applying a machine learning algorithm to the prosodic features as a first emotion identification process,
acquire, via a user state acquisition unit, face image data and biometric information data of an elderly user as a receiver,
estimate an emotional state of the elderly user from the face image data and the biometric information data by applying an image analysis model and a time-series analysis model as a second emotion identification process,
construct, based on the utterance text data, speaker emotion information obtained by the first emotion identification process, and elderly user emotion information obtained by the second emotion identification process, a prompt sentence to be input to a generative artificial intelligence model,
input the prompt sentence to the generative artificial intelligence model and obtain, from the generative artificial intelligence model, sign expression data or intermediate representation data corresponding to a sign expression,
generate, based on the sign expression data, motion data of a virtual character, and
control a display device so as to render an animation of sign or gesture of the virtual character by dynamically adjusting at least a motion speed and a facial parameter in accordance with the emotional state of the elderly user.

### (Supplementary 2)

The system according to supplementary 1,
wherein the processor is configured to
refer to storage that records baseline facial features and baseline biometric features for each elderly user,
adjust the emotional state of the elderly user estimated in the second emotion identification process based on a degree of deviation between current features and the baseline features so as to perform emotion estimation adapted to individual differences,
generate, by a prompt generation process, the prompt sentence such that the prompt sentence includes conditions relating to at least politeness, length of explanation text, presence or absence of a reassurance message, and a gesture expression style, the conditions being determined based on the speaker emotion information and the elderly user emotion information, and
obtain, from the generative artificial intelligence model in response to the prompt sentence, sign expression data including rephrased text for the elderly user, a sequence of sign glosses, and motion parameters corresponding to the respective glosses.

### (Supplementary 3)

The system according to supplementary 1,
wherein the processor is configured to
generate joint transformation data for a skeletal structure of the virtual character based on at least hand shape information, position information, movement information, and facial tag information included in the sign expression data,
generate intermediate frames between successive sign units by applying an interpolation algorithm in accordance with changes between the successive sign units so as to form a smooth three-dimensional animation, and
when the elderly user emotion information indicates an anxious state, extend motion time parameters and emphasize calm facial tags in the animation, thereby visually presenting contents of the speech and emotional states of both the caregiver and the elderly user in an easily understandable manner in a caregiving scene.

What is claimed is:

1. A system comprising:
circuitry configured to:
receive, via a communication interface coupled to a packet-switched network, audio information;
analyze the audio information to generate character information;
extract prosodic feature quantities from the audio information and classify the prosodic feature quantities to specify emotion information;
generate a visual expression representation on a basis of the character information and the emotion information; and
convert the visual expression representation into animation data and transmit the animation data to a user terminal via the packet-switched network.

2. The system according to claim 1, wherein the circuitry is further configured to analyze the audio information by extracting frame-based feature vectors from the audio information, inputting the feature vectors to an acoustic model implemented as a deep neural network, and combining an output of the acoustic model with a language model using a decoding algorithm to generate the character information.

3. The system according to claim 2, wherein the acoustic model comprises a plurality of layers including at least one of convolutional layers, recurrent layers, and self-attention layers, and an output layer corresponding to phonetic or subword units, the acoustic model having been trained by minimizing an objective function comprising at least one of a connectionist temporal classification loss and a cross-entropy loss using gradient-based optimization.

4. The system according to claim 3, wherein the decoding algorithm comprises beam search that maintains a search graph of candidate token sequences, applies a pruning strategy to discard low-probability paths, and references field-specific dictionary data to adjust scores for domain-specific terms.

5. The system according to claim 1, wherein the prosodic feature quantities comprise at least fundamental frequency, intensity, speech rate, and pause duration, and the circuitry segments the audio information into analysis windows and computes statistical descriptors comprising at least one of mean, variance, range, and slope for each prosodic feature quantity over the analysis windows.

6. The system according to claim 5, wherein the circuitry classifies the prosodic feature quantities by inputting normalized feature vectors to an emotion classifier comprising at least one of a long short-term memory network, a gated recurrent unit network, and a transformer-based classifier, the emotion classifier having been trained using supervised learning with labeled emotional speech data and a cross-entropy loss function.

7. The system according to claim 6, wherein the circuitry is further configured to store user-specific baseline profiles and normalize the prosodic feature quantities relative to the baseline profiles to distinguish emotional variation from individual speaking style prior to classification.

8. The system according to claim 1, wherein the visual expression representation comprises a sign language intermediate representation including a sequence of sign units, grammatical annotations, non-manual markers, and a target sign language type.

9. The system according to claim 8, wherein the circuitry is further configured to perform tokenization, part-of-speech tagging, and syntactic parsing on the character information, apply rule-based transformations specific to sign language word order including topic-comment rearrangement, and insert non-manual markers on a basis of the emotion information and syntactic emphasis.

10. The system according to claim 9, wherein the circuitry is further configured to construct a prompt sentence including the sign language intermediate representation, the emotion information, and the target sign language type, supply the prompt sentence to a generative AI model, and obtain structured sign language expression data comprising hand shape, position, movement, duration, and facial expression tags.

11. The system according to claim 10, wherein the circuitry is further configured to convert the structured sign language expression data into an animation script comprising skeletal information defining a hierarchical arrangement of virtual joints, joint angle information specifying time-varying rotations of individual joints, and facial expression information comprising blendshape weights controlling visible changes in a virtual character face.

12. The system according to claim 1, wherein the animation data comprises an animation script including skeletal information, joint angle information, and facial expression information, and the circuitry is further configured to apply motion smoothing processing comprising a low-pass filter to the joint angle information to reduce discontinuities between consecutive animation frames.

13. The system according to claim 12, wherein the circuitry is further configured to transmit the animation script to the user terminal for three-dimensional rendering of a virtual character, and the user terminal is configured to change an appearance and motion characteristics of the virtual character on a basis of a user setting.

14. The system according to claim 1, wherein the circuitry is further configured to preprocess the audio information prior to analysis by performing at least one of noise reduction processing, voice activity detection, amplitude normalization, and resampling to a target sampling frequency.

15. The system according to claim 1, wherein the circuitry is further configured to construct a plurality of prompt sentences for a generative AI model, the plurality of prompt sentences comprising at least a first prompt sentence for generating the visual expression representation including expression tags and movement instructions, and a second prompt sentence for generating explanation text describing the visual expression representation for a human reviewer.

16. The system according to claim 15, wherein the circuitry is further configured to store processing history comprising at least one of character information, emotion information, visual expression representation data, and user feedback for each interaction, and to update at least one of a parameter of the generative AI model and content of the plurality of prompt sentences on a basis of accumulated processing history.

17. The system according to claim 1, wherein the circuitry is further configured to train at least one of the acoustic model and the emotion classifier using data augmentation techniques comprising at least one of time-warping, frequency-masking, and additive noise injection.

18. A system comprising:
circuitry configured to:
receive, via a communication interface operating over a packet-switched network, audio information, and preprocess the audio information by performing noise reduction processing and amplitude normalization;
extract frame-based feature vectors from the audio information and input the feature vectors to an acoustic model comprising convolutional layers and self-attention layers to generate phonetic representations, and combine the phonetic representations with a language model using beam search decoding to generate character information;
extract prosodic feature quantities comprising fundamental frequency, intensity, speech rate, and pause duration from the audio information, compute statistical descriptors for each prosodic feature quantity over analysis windows, and classify the prosodic feature quantities using an emotion classifier comprising at least one of a long short-term memory network and a transformer-based classifier to specify emotion information;
generate a sign language intermediate representation comprising a sequence of sign units, grammatical annotations, non-manual markers, and a target sign language type on a basis of the character information and the emotion information;
construct a prompt sentence including the sign language intermediate representation, the emotion information, and the target sign language type, supply the prompt sentence to a generative AI model, and obtain structured sign language expression data comprising hand shape, position, movement, duration, and facial expression tags;
convert the structured sign language expression data into an animation script comprising skeletal information, joint angle information, and facial expression information, and apply motion smoothing processing to the joint angle information; and
transmit the animation script to a user terminal via the packet-switched network for three-dimensional rendering of a virtual character with user-configurable appearance and motion characteristics.

19. The system according to claim 18, wherein the circuitry is further configured to store user-specific baseline profiles and normalize the prosodic feature quantities relative to the baseline profiles prior to classification, and to store processing history for each interaction and update at least one of a parameter of the generative AI model and content of the prompt sentence on a basis of accumulated processing history.

20. A method performed by circuitry of a system, the method comprising:
receiving, via a communication interface coupled to a packet-switched network, audio information;
analyzing the audio information to generate character information;
extracting prosodic feature quantities from the audio information and classifying the prosodic feature quantities to specify emotion information;
generating a visual expression representation on a basis of the character information and the emotion information; and
converting the visual expression representation into animation data and transmitting the animation data to a user terminal via the packet-switched network.
